(19) United States
(12) Patent Application Publication
(10) Pub. No.: US 2006/0278753 A1
(43) Pub. Date: Dec. 14, 2006

(54) Controller for a life support system

(76) Inventors: Kartik B. Ariyur, Minnetonka, MN (US); Ranjana Ghosh, Minneapolis, MN (US); Sonja Glavaski-Radovanovic, Plymouth, MN (US); Nitin Lamba, Plymouth, MN (US); Dharmashankar Subramanian, New Hope, MN (US)

Correspondence Address: HONEYWELL INTERNATIONAL INC., 101 COLUMBIA ROAD, P O BOX 2245, MORRISTOWN, NJ, 07962-2245, US

(21) Appl. No.: 11/148,526

(22) Filed: Jun. 8, 2005

(51) Int. Cl. B64D 45/00

(52) U.S. Cl. 244/1 R

(57) ABSTRACT

A system for a variable configuration CO₂ removal within an air recovery framework. The system may include description and model development. There may be time modeling that incorporates inter-mode switching time and intra-mode dynamics time. The intra-mode dynamics time may have a mode time interval divided into finite elements and the finite elements may each have collocation points. There may be nonlinear model predictive control with objective function development and tuning. Statistical verification of controller safety performance may be included.

### BACKGROUND

The present invention pertains to controllers and particularly to controllers for life support systems. More particularly, the invention pertains to adaptations of model predictive controls.

### SUMMARY

The invention may be a controller system for a hybrid nonlinear life support system.

### BRIEF DESCRIPTION OF THE DRAWING

FIGS. 1a and 1b are summary and more detailed block diagrams of the present control system;

FIG. 2 shows an illustrative example of a VCCR system;

FIG. 3 shows a time discretization schematic;

FIG. 4 shows a bed layout with a solid phase profile with first three terms in the objective;

FIG. 5 shows a bed layout with a solid phase profile with desorption driver and CO₂ driver terms added to the objective;

FIG. 6 shows the bed layout with solid phase profile with a low bed CO₂ driver term added to the objective function;

FIG. 7 shows NMPC controller performance with high initial CO₂ in the crew cabin;

FIG. 8 shows NMPC controller performance with low initial CO₂ in the crew cabin;

FIG. 9 shows CO₂ concentration profiles for two controllers in the crew cabin with one active adsorber and single side operation;

FIG. 10 shows bed solid phase CO₂ profiles for two controllers with in adsorber bed with one active adsorber and single side operation;

FIG. 11 shows a comparison of controller performance in the crew cabin with degraded adsorbers (half adsorb/desorb rates);

FIG. 12 shows a comparison of controller performance in the adsorber bed with degraded adsorbers; and

FIG. 13 is a diagram of the controller switching rules.

### DESCRIPTION

The present invention may be a control design for a variable configuration CO₂ removal (VCCR) system, which exhibits a hybrid dynamical character due to the various modes in which one needs to operate the system. The VCCR may be part of an overall air recovery system of an intended human life-support system for space exploration. The objective of the control problem is to track a desired concentration profile of CO₂ in a crew cabin while also ensuring safety in terms of keeping the CO₂ and O₂ concentrations in the crew cabin within permissible bounds. An adaptation of the model predictive control technique may be presented for the nonlinear hybrid dynamic system. The problem structure may be exploited and the hybrid optimization problem may be mapped onto a continuous nonlinear program with the aid of an appropriate representation of time and set definitions. A systematic approach may be presented for designing the appropriate objective function for the non-linear model predictive control regulation problem that achieves a long-term, cyclic steady state. Also presented may be a simulation-based hybrid feedback controller. The performances of the two controllers during off-nominal and failure conditions may be compared to highlight the benefits of a systematically designed non-linear model predictive control (NMPC) controller.

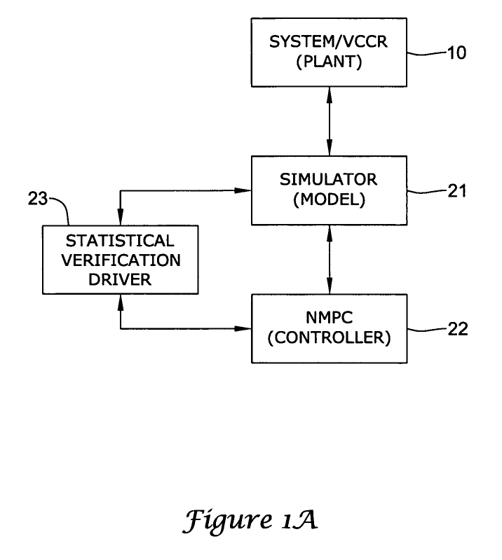

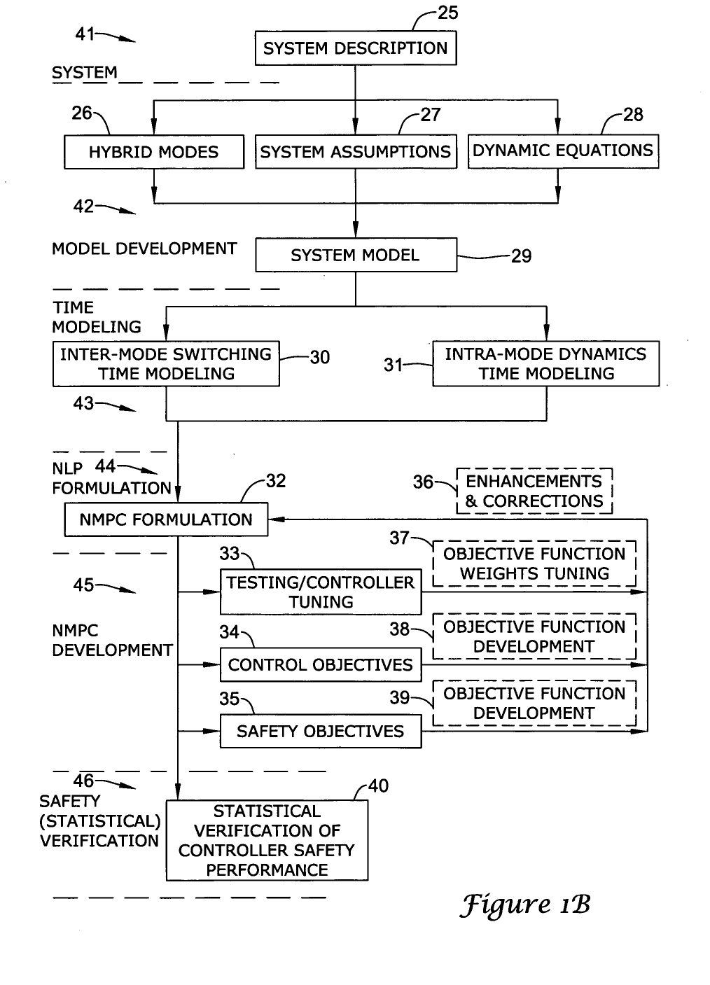

FIG. 1a is a block diagram of the present system. A system/VCCR 10 may have a bi-directional connection with a simulator (model) 21. Simulator 21 may have a bi-directional connection with an NMPC (controller) 22. A statistical verification driver may have a bi-directional connection with simulator 21 and NMPC 22.

FIG. 1b is a diagram of a process of the present system. A system description 25 of a system section 41 may have an output to hybrid modes 26, system assumptions 27 and dynamic equations 28 of the model development section 42. Outputs of hybrid modes 26, system assumptions 27 and dynamic equations 28 may go to a system model 29 of section 42. An output of system model 29 may go to an inter-mode switching time modeling 30 and an intra-mode dynamics time modeling 31 of a time modeling section 43. The outputs of the inter-mode switching time modeling 30 and an intra-mode dynamics time modeling 31 may go to an NMPC formulation 32 of a nonlinear program (NLP) section 44. An output of the NMPC formulation 32 may go to a testing/controller tuning 33, control objectives 34 and safety objectives 35 of an NMPC development section 45. The outputs of the testing/controller tuning 33, control objectives 34 and safety objectives 35 may output objective function weights tuning 37, objective function development 38 and objective function development 39, respectively, which may go as an enhancements and corrections 36 to the NMPC formulation 32. An output of the NMPC formulation 32 may go to a statistical verification of controller safety performance 40 of a safety (statistical) verification section 46.

A specific application domain of the present system may include advanced life support systems that are used for manned space exploration missions. Hybrid dynamic models may describe hierarchical processes, which evolve according to different sets of lower level dynamic components (differential or difference equations) depending on the upper level logical/discrete mode that characterizes the system, at any given point in time. Hybrid systems may have many applications and many approaches to develop control schemes for them exist. In particular, the control problem of a variable configuration CO₂ removal (VCCR) system, which exhibits a hybrid dynamical character due the various configurations/modes in which one needs to operate the system, may be considered. The VCCR may be a part of an overall air recovery system, which in turn is part of an intended human life-support system for space exploration.

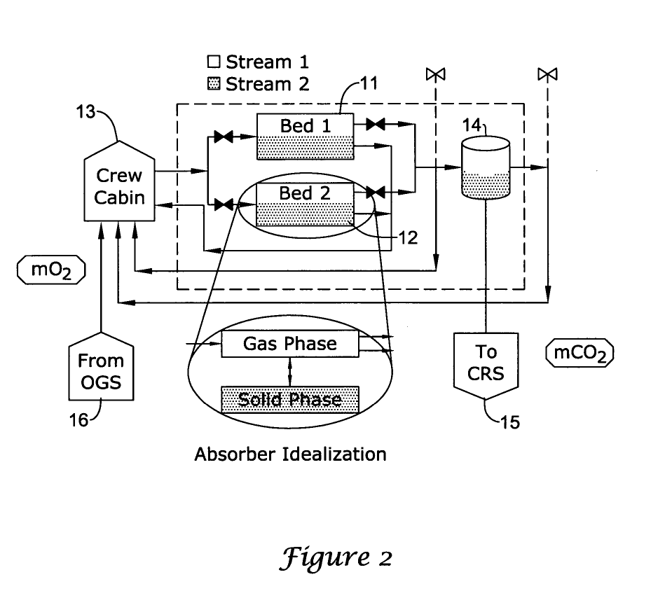

FIG. 2 shows an illustrative example of a VCCR system 10. The basic functions of the VCCR system may include recovery of CO₂ from the crew cabin 13 by adsorption into one of two adsorber beds 11 and 12. It may also include desorbing the accumulated CO₂ and sending it to an accumulator 14 for downstream CO₂ Removal System (CRS). One may look at a physical realization of the VCCR system 10 (a configuration obtained from Metrica Traclabs) that consists only of the crew cabin 13, two adsorber beds 11 and 12, and the CO₂ accumulator 14, without the CRS system 15, as shown in FIG. 2. The physical configuration of the system 10 may be such that when one of the adsorber beds 11 or 12 is connected to the crew cabin 13, and is undergoing CO₂ uptake via adsorption, the other bed is undergoing either air-save or desorption, with the following synchronized operation. During the time interval (say, ‘half-cycle’) when the adsorbing bed (11 or 12) returns CO₂-lean air back into the cabin 13, the other bed may involve two modes of operation in sequence—the air-save mode and the CO₂-desorb mode. In the air-save mode, the desorbing bed may recycle CO₂-lean air back into the cabin 13 from its gas phase. For the remainder of the ‘half-cycle’, it may operate in the CO₂-desorb mode in which it delivers CO₂ that is released from the solid phase. This CO₂ may either be vented, or be accumulated into the CO₂ accumulator 14. During maintenance, the accumulator 14 may also be used to send CO₂ back into the cabin 13, if needed. The adsorber beds 11 and 12 may have a saturation capacity beyond which they cannot adsorb any more CO₂. As a result, after every adsorption step, the beds 11 and 12 may change their roles and the adsorbing bed may start air-save followed by desorption, while the re-generated bed may be connected to the cabin 13 for adsorption. Therefore, the system 10 may be operated in a cyclical pattern of operation. At any given point in time, the system 10 may exist in any of four different hybrid modes, which form a sequence of four quarter-cycles that compose one full-cycle of operation. The modes include: 1) Bed 11 in adsorb, and bed 12 in air-save; 2) Bed 11 in adsorb, and bed 12 in desorb; 3) Bed 12 in adsorb, and bed 11 in air-save; and 4) Bed 12 in adsorb, and bed 11 in desorb.

The dynamic equations that describe the state evolution in the adsorber beds 11 and 12, crew cabin 13, and the CO₂ accumulator 14 may be different, depending on what mode of operation applies to the system. Lastly, the overall system may have an oxygen generation system (OGS) 16, which may send make-up O₂ into the cabin, if required.

One may let C ∈ {CO₂, O₂,inert} represent a component in the system, and j ∈ {1,2} represent a bed 11, 12 in the system 10. Also, one may let subscript C denote the crew cabin 13, and subscript A denotes the CO₂ accumulator 14. The subscripts, variables and parameters used here are may be defined in this specification. For the four modes of operation, the dynamical equations for the cabin 13, the adsorbers and the accumulator 14 may take the following form. In the first mode, adsorber j is adsorbing, adsorber j′≠j is in air-save. In this mode, adsorber j may be connected to the cabin 13 and CO₂ from the cabin gets accumulated at the corresponding rate of adsorption. Stream 1 from the adsorber bed, j, into the cabin 13, may be the only outflow from the adsorber bed. There may be another inlet flow into the cabin 13 because adsorber j′ is sending air back since it is in air-save mode. Hence, the component mass balance equation of the cabin 13 may become:

$$[ \begin{matrix}{v}_{1} ρ ( c , j ) - {v}_{1} {ρ}_{C} ( c ) + {v}_{2} ρ ( c , {j}^{′} ) + \\ {r}_{C} ( c ) + m ( c )\end{matrix} ] = {V}_{C} \frac{ⅆ {ρ}_{C} ( c )}{ⅆ t} \qquad ( 1 )$$

One may note that the generation rate r_{C}(c) may appear positive for CO₂, negative for O₂ and zero for inert. For adsorber j, the component balance may become:

$$\begin{matrix}{v}_{1} {ρ}_{C} ( c ) - {v}_{1} ρ ( c , j ) - {r}_{ads} ( j , c ) = {V}_{j} \frac{ⅆ ρ ( c , j )}{ⅆ t} & ( 2 ) \\ \frac{ⅆ Q ( c , j )}{ⅆ t} = {r}_{ads} ( j , c ) & ( 3 )\end{matrix}$$

Similarly, the component mass balances for adsorber j′ may become:

$$\begin{matrix}- {v}_{2} ρ ( c , {j}^{′} ) = {V}_{{j}^{′}} \frac{ⅆ ρ ( c , {j}^{′} )}{ⅆ t} & ( 4 ) \\ \frac{ⅆ Q ( c , {j}^{′} )}{ⅆ t} = 0 & ( 5 )\end{matrix}$$

Since there is no O₂ and inerts in the accumulator, its mass balance may take the form:

$$\frac{ⅆ {Q}_{A} ( c )}{ⅆ t} = - m ( c ) \qquad ( 6 )$$

The negative sign indicates that the CO₂ make-up stream is an outlet from the accumulator 14 and hence may reduce the mass inside it.

In the second mode, adsorber j is adsorbing, adsorber j′≠j is desorbing. Stream 2 does not have any flow into the cabin 13, so the v₂ term in (1) disappears and the equation for cabin may take the following form.

$$[ \begin{matrix}{v}_{1} ρ ( c , j ) - {v}_{1} {ρ}_{C} ( c ) + \\ {r}_{C} ( c ) + m ( c )\end{matrix} ] = {V}_{C} \frac{ⅆ {ρ}_{C} ( c )}{ⅆ t} \qquad ( 7 )$$

The dynamics of adsorber j may remain the same in this mode. However, adsorber j′ desorbs CO₂ and mass balance may become:

$$\begin{matrix}- {v}_{2} ρ ( c , {j}^{′} ) + {r}_{des} ( j , c ) = {V}_{{j}^{′}} \frac{ⅆ ρ ( c , {j}^{′} )}{ⅆ t} & ( 8 ) \\ \frac{ⅆ Q ( c , {j}^{′} )}{ⅆ t} = - {r}_{des} ( j , c ) , for c = {CO}_{2} & ( 9 )\end{matrix}$$

Now that the outlet of adsorber j′ may be connected to the accumulator 14, its mass balance modifies to the following.

$$\frac{ⅆ {Q}_{A} ( c )}{ⅆ t} = {v}_{2} ρ ( c , {j}^{′} ) - m ( c ) , for c = {CO}_{2} \qquad ( 10 )$$

Permissible combinations of the above sets of dynamic equations (modes) may be taken to describe the mode-dependent dynamics of the VCCR system.

There may be non-linear predictive control in the system. Controller synthesis with mathematical programming may be based on a so-called receding horizon philosophy. This may be done on linear dynamic systems and be referred to as model predictive control (MPC). This concept may be adapted to work with the above nonlinear, hybrid system, and result in a nonlinear model predictive control (NMPC). A nonlinear formulation of a controller may be embedded into a NMPC framework.

The permissible modes of operation of the system and the cyclical pattern of these modes may be noted from the perspective of developing a nonlinear programming based controller. For a given number of full-cycles under consideration, the control inputs to be decided by a controller may include the following for each quarter-cycle: 1) Volumetric flow rate from the cabin 13 to the adsorbing bed 11 or 12; 2) Volumetric flow rate out of the air-saving, or desorbing bed 12 or 11; 3) Time duration; 4) Mass flow rate of CO₂ from the accumulator 14 to cabin 13; and 5) Mass flow rate of O₂ from the OGS 16 to the cabin 13.

In a linear MPC and NMPC, the continuous time axis may be discretized into a discrete number of time points, and the differential equations may be converted into difference equations applied at these time points. The number of time points may denotes the regulation horizon over which the MPC problem is formulated. An adaptation of this concept in the NMPC framework for the VCCR physical system may be as follows.

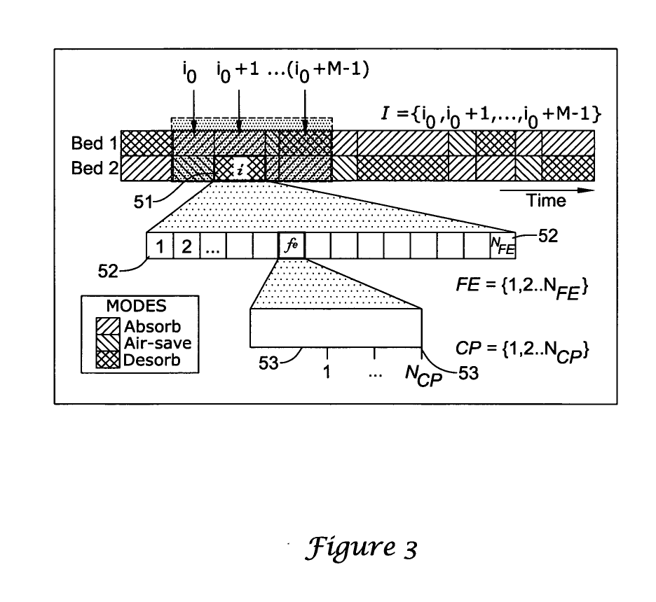

The NMPC regulation horizon may be defined at the time scale of quarter cycles, i.e., a finite number of quarter cycles into the future. This is a subtle, and novel, departure from classical linear MPC, where the control regulation horizon is defined in terms of the number of discretization points. Secondly, the duration of each quarter cycle may be determined as a decision variable by the NMPC controller. In other words, the NMPC controller may decide when to switch from one mode to another. Also, within each quarter cycle, the NMPC framework may utilize an appropriate nonlinear model of the system to predict the future state. A collocation on finite elements may be used to convert the infinite dimensional, continuous, differential equations into a finite dimensional, discretized set of algebraic equations within each quarter cycle (see FIG. 3). Based on a prediction done over the regulation horizon, a future optimal control maneuver may be computed for each quarter cycle in the horizon in terms of the control inputs. The control inputs that are implemented may correspond to the first quarter cycle.

FIG. 3 shows a time discretization schematic. Details of the nonlinear programming formulation within the NMPC framework may be noted in the following. Firstly, the time axis may be modeled into a specified number of quarter-cycles along with some set definitions (Table 1) that aid in converting a set of four mode-dependent sets of dynamic equations into a single finite-dimensional set of discretized algebraic equations. Let I={i₀,i₀+1, . . . ,i₀+M-1}, where M is the number of quarter-cycles under consideration (i.e., the NMPC regulation horizon, as adapted for the present approach). The system may start with any mode, with the only restriction that the two beds follow the cyclical pattern for subsequent quarter-cycles. Further, subsets of I (Table 1) may be defined based on the cyclical pattern of operation, and one may let m=imod4, ∀i ∈I. These sets may exploit the cyclic nature of the process and identify the correct set of differential equations that apply to each quarter cycle in the regulation horizon.

For each quarter cycle, i, the time interval 51 of interest, T(i), which is the same of the (unknown) duration of the quarter cycle, may be divided into N_{FE} finite elements 52 of length h_{fe}, such that

$${\sum }_{fe = 1}^{fe = {N}_{FE}} {h}_{fe} = T ( i ) \qquad ( 11 )$$

The finite elements 52 may be taken to be of equal size. If the time duration, T(i), is represented by the interval [t_{i,0},t_{i,f}], then

$${t}_{i , fe} = {t}_{i , 0} + {\sum }_{l = 1}^{l = fe} {h}_{l} , ∀ fe = 1 , … , {N}_{FE} ( note \text{:} {t}_{i , {N}_{FE}} = {t}_{i , f} ) \qquad ( 12 )$$

TABLE 1
SET DEFINITIONS

| Bed | Mode | Definition |
|---|---|---|
| 1 | Adsorb | ${B}_{A , 1} = \{ i \vert ( m = 1 ) ⋁ ( m = 2 ) \}$ |
| 2 | Adsorb | ${B}_{A , 2} = \{ i \vert ( m = 3 ) ⋁ ( m = 0 ) \}$ |
| 1 | Air-Save | B_{AS,1} = {i\|(m = 3)} |
| 2 | Air-Save | B_{AS,2} = {i\|(m = 1)} |
| 1 | Desorb | R_{D,1} = {i\|(m = 0)} |
| 2 | Desorb | B_{D,2} = {i\|(m = 2)} |
| 1,2 | Adsorb | ${B}_{A} = \{ ( i , j ) \vert \begin{matrix}[ ( j = 1 ) ⋀ ( i ε {B}_{A , 1} ) ] \\ ⋁ [ ( j = 2 ) ⋀ ( i ε {B}_{A , 2} ) ] \}\end{matrix}$ |
| 1,2 | Air-Save | ${B}_{AS} = \{ ( i , j ) \vert \begin{matrix}[ ( j = 1 ) ⋀ ( i ε {B}_{AS , 1} ) ] ⋁ \\ [ ( j = 2 ) ⋀ ( i ε {B}_{AS , 2} ) ] \}\end{matrix}$ |
| 1,2 | Desorb | ${B}_{D} = \{ ( i , j ) \vert \begin{matrix}[ ( j = 1 ) ⋀ ( i ε {B}_{D , 1} ) ] \\ ⋁ [ ( j = 2 ) ⋀ ( i ε {B}_{D , 2} ) ] \}\end{matrix}$ |

Within each finite element 52, N_{CP} collocation points 53 may be placed. The time profiles of algebraic and differential variables may be approximated using derivatives and values evaluated at the N_{CP} collocation points, whose relative position within each finite element is the same. The collocation points may be positioned as,
τ_{i,fe,cp}=t_{i,fe-1}+h_{fe}ρ_{cp},∀cp=1, . . . , N_{CP} (13)
(Note that τ_{i,fe,N}_{_{CP}}=t_{i,fe}).

In the above equation, ρ_{cp} ∈ [0,1] may be chosen to be the shifted roots of orthogonal polynomials of degree N_{CP}. Radau points may be used here as they may allow a convenient setting of constraints at the end of each element. A monomial basis representation is used for the differential profiles. So a differential variable, z, in quarter cycle, i, and finite element, fe, may be given as:

$${z}_{i} ( t ) = z ( {t}_{i , fe - 1} ) + {h}_{fe} {\sum }_{cp = 1}^{{N}_{CP}} {Ω}_{cp} ( \frac{t - {t}_{i , fe - 1}}{{h}_{fe}} ) {( \frac{ⅆ {z}_{i}}{ⅆ t} )}_{i , fe , cp} \\ ∀ t ∈ [ {t}_{i , fe - 1} , {t}_{i , fe} ] \qquad ( 14 )$$

In the above equation, the time polynomial Ω_{cp} may be of an order N_{CP} and satisfy the following conditions:
Ω_{cp}(0)=0, for cp=1, . . . ,N_{CP}
Ω_{cp}(ρₖ)=δ_{q,k}, for cp=1, . . . ,N_{CP};k=1, . . . ,N_{CP} (15)

The ODE's may be written at each collocation point with each finite element by introducing a variable for each state-derivative. Continuity constraints may be imposed at the boundaries of each finite element, and at the boundaries of each quarter cycle time slot.

The discretized set of algebraic equations may transform into system constraints that represent the dynamics in the nonlinear program (NLP) formulation. The crew cabin 13 material balance in the air-save and desorb mode respectively may take the following form upon discretization:

$$\begin{matrix}{V}_{C} ( {ρ}_{C}^{Gra} ( c , i , fe , cp ) ) = [ \begin{matrix}{v}_{1} ( i ) ( ρ ( c , i , j , fe , cp ) - {ρ}_{C} ( c , i , fe , cp ) ) + \\ {r}_{C} ( c ) + {v}_{2} ( i ) ρ ( c , i , {j}^{′} , fe , cp ) + \dot{m} ( i , c )\end{matrix} ] & ( 16 ) \\ ∀ i ∈ I , fe ∈ FE , cp ∈ CP , c ∈ C , & \\ ( i , j , {j}^{′} ) \vert ( j \neq {j}^{′} , \& ( i , j ) ∈ {B}_{A} , \& ( i , {j}^{′} ) ∈ {B}_{AS} ) . & \\ {V}_{C} ( {ρ}_{C}^{Gra} ( c , i , fe , cp ) ) = [ \begin{matrix}{v}_{1} ( i ) ( \begin{matrix}ρ ( c , i , j , fe , cp ) - \\ {ρ}_{C} ( c , i , fe , cp )\end{matrix} ) + \\ {r}_{C} ( c ) + \dot{m} ( i , c )\end{matrix} ] & ( 17 ) \\ ∀ i ∈ I , fe ∈ FE , cp ∈ CP , c ∈ C , & \\ ( i , j , {j}^{′} ) \vert j \neq {j}^{′} , \& ( i , j ) ∈ {B}_{A} , \& ( i , {j}^{′} ) ∈ {B}_{D} . & \end{matrix}$$

The adsorber bed material balances in the adsorb mode may take the following form upon discretization:

$$\begin{matrix}{V}_{j} {ρ}^{Gra} ( c , i , j , fe , cp ) = [ \begin{matrix}{v}_{1} ( i ) ( \begin{matrix}{ρ}_{C} ( c , i , fe , cp ) - \\ ρ ( c , i , j , fe , cp )\end{matrix} ) - \\ {r}_{ads} ( j , c )\end{matrix} ] & ( 18 ) \\ ∀ i ∈ I , fe ∈ FE , cp ∈ CP , c ∈ C , ( i , j ) ∈ {B}_{A} & \\ {Q}^{Gra} ( c , i , j , fe , cp ) = {r}_{ads} ( j , c ) & ( 19 ) \\ ∀ i ∈ I , fe ∈ FE , cp ∈ CP , c ∈ C , ( i , j ) ∈ {B}_{A} & \end{matrix}$$

The adsorber bed material balances in the air-save mode may take the following form upon discretization:
Vⱼρ^{Gra}(c,i,j,fe,cp)=[−c₂(i)ρ(c,i,j,fe,cp)]
∀i ∈I, fe ∈ FE, cp ∈ CP, c ∈ C,(i,j) ∈ B_{AS} (20)
Q^{Gra}(c,i,j,fe,cp)=0
∀i ∈ I, fe ∈ FE, cp ∈ CP,c ∈ C,(i,j) ∈ B_{AS} (21)
The adsorber bed material balances in the desorb mode may take the following form upon discretization:

$$\begin{matrix}{V}_{j} {ρ}^{Gra} ( c , i , j , fe , cp ) = [ \begin{matrix}- {v}_{2} ( i ) ρ ( c , i , j , fe , cp ) + \\ {r}_{des} ( j , c )\end{matrix} ] & ( 22 ) \\ ∀ i ∈ I , fe ∈ FE , cp ∈ CP , c ∈ C , ( i , j ) ∈ {B}_{D} & \\ {Q}^{Gra} ( c , i , j , fe , cp ) = - {r}_{des} ( j , c ) & ( 23 ) \\ ∀ i ∈ I , fe ∈ FE , cp ∈ CP , c ∈ C , ( i , j ) ∈ {B}_{D} & \end{matrix}$$

The accumulator 14 material balances in the air-save and desorb mode respectively may take the following form upon discretization:
Q_{A}^{Gra}(c,i,fe,cp)=−\dot{m}(i,c)
∀c=CO₂, fe ∈ FE, cp ∈ CP, ∀i ∈ I, j|(i,j) ∈ B_{AS} (24)
Q_{A}^{Gra}(c,i,fe,cp)=−\dot{m}(i,c)+v₂(i)ρ(c,i,j,fe,cp)
for c=CO₂, ∀i ∈ I, fe ∈ FE,cp ∈ CP,(i,j) ∈ B_{D} (25)

The mass fraction of every component in the crew cabin 13 may be defined with the following constraint:

$${y}_{C} ( c , i , fe , cp ) {\sum }_{{c}^{′} ∈ C} {ρ}_{C} ( {c}^{′} , i , fe , cp ) = {ρ}_{C} ( c , i , fe , cp ) \qquad ( 26 )$$

∀i ∈ I, fe ∈ FE, cp ∈ CP,c ∈ C
The constraints that model the continuity conditions across the quarter-cycle time slots in the discretized model may be as follows:
ρ_{C}⁰(c,i,1)=ρ_{C}(c,i−1,N_{FE},N_{CP})
Q_{A}⁰(c,i,1)=Q_{A}(c,i−1,N_{FE},N_{CP})
∀ i∈I|i>i₀,c ∈ C (27)
ρ⁰(c,i,j,1)=ρ(c,i−1,j,N_{FE}N_{CP})
Q⁰(c,i,j,1)=Q(c,i−1,j,N_{FE},N_{CP})
∀ i∈I|i>i₀,j ∈ J, c ∈ C (28)
To determine variable values at every collocation point within finite elements, following constraints may be obtained:

$$\begin{matrix}{ρ}_{C} ( c , i , fe , cp ) = {ρ}_{C}^{0} ( c , i , fe ) + \frac{T ( i )}{{N}_{FE}} {\sum }_{{cp}^{′} = 1}^{{N}_{CP}} Ω ( {cp}^{′} , cp ) [ {ρ}_{C}^{Gra} ( c , i , fe , {cp}^{′} ) ] & ( 29 ) \\ {Q}_{A} ( c , i , fe , cp ) = {Q}_{A}^{0} ( c , i , fe ) + \frac{T ( i )}{{N}_{FE}} {\sum }_{{cp}^{′} = 1}^{{N}_{CP}} Ω ( {cp}^{′} , cp ) [ {Q}_{A}^{Gra} ( c , i , fe , {cp}^{′} ) ] & \\ ∀ i ∈ I , fe ∈ FE , cp ∈ CP , c ∈ C & \\ ρ ( c , i , j , fe , cp ) = {ρ}^{0} ( c , i , j , fe ) + \frac{T ( i )}{{N}_{FE}} {\sum }_{{cp}^{′} = 1}^{{N}_{CP}} Ω ( {cp}^{′} , cp ) [ {ρ}^{Gra} ( c , i , j , fe , {cp}^{′} ) ] & ( 30 ) \\ Q ( c , i , j , fe , cp ) = {Q}^{0} ( c , i , j , fe ) + \frac{T ( i )}{{N}_{FE}} {\sum }_{{cp}^{′} = 1}^{{N}_{CP}} Ω ( {cp}^{′} , cp ) [ {Q}^{Gra} ( c , i , j , fe , {cp}^{′} ) ] & \\ ∀ i ∈ I , j ∈ J , fe ∈ FE , cp ∈ CP , c ∈ C & \end{matrix}$$

Similarly, the constraints that model the continuity conditions across finite elements may take the following form:

$$\begin{matrix}{ρ}_{C}^{0} ( c , i , fe ) = {ρ}_{C}^{0} ( c , i , fe - 1 ) + \frac{T ( i )}{{N}_{FE}} {\sum }_{{cp}^{′} = 1}^{{N}_{CP}} Ω ( {cp}^{′} , {N}_{CP} ) [ {ρ}_{C}^{Gra} ( c , i , fe , {cp}^{′} ) ] & ( 31 ) \\ {Q}_{A}^{0} ( c , i , fe ) = {Q}_{A}^{0} ( c , i , fe - 1 ) + \frac{T ( i )}{{N}_{FE}} {\sum }_{{cp}^{′} = 1}^{{N}_{CP}} Ω ( {cp}^{′} , {N}_{CP} ) [ {Q}_{A}^{Gra} ( c , i , fe , {cp}^{′} ) ] & \\ ∀ i ∈ I , fe ∈ FE \vert fe > 1 , c ∈ C & \\ {ρ}^{0} ( c , i , j , fe ) = {ρ}^{0} ( c , i , j , fe - 1 ) + \frac{T ( i )}{{N}_{FE}} {\sum }_{{cp}^{′} = 1}^{{N}_{CP}} Ω ( {cp}^{′} , {N}_{CP} ) [ {ρ}^{Gra} ( c , i , j , fe , {cp}^{′} ) ] & ( 32 ) \\ {Q}^{0} ( c , i , j , fe ) = {Q}^{0} ( c , i , j , fe - 1 ) + \frac{T ( i )}{{N}_{FE}} {\sum }_{{cp}^{′} = 1}^{{N}_{CP}} Ω ( {cp}^{′} , {N}_{CP} ) [ {Q}^{Gra} ( c , i , j , fe , {cp}^{′} ) ] & \\ ∀ i ∈ I , j ∈ J , fe ∈ FE \vert fe > 1 , c ∈ C & \end{matrix}$$

Additionally, the length of time slot may also be bounded by appropriate values to avoid getting trivial solutions (with zero length of time slots).

Lastly, at the end of the air-save step, a pure vacuum cannot be attained and the bed fluid phase may only reach a certain minimum pressure. So a minimum total concentration corresponding to that attainable pressure may be defined. Moreover, in order to prevent loss of oxygen and inert into the CO₂ accumulator 14, a maximum total concentration may also be defined.

The classical objective function used in linear and nonlinear MPC may be reference state trajectory tracking. For complex, hybrid systems, such an objective function might not be sufficient to address the desired trade-off between long-term nominal stability and short horizon of control calculation. A systematic procedure may be used to develop an appropriate objective function, as a weighted sum of various measures. One may start with two basic measures that correspond to reference state trajectory tracking, and add a third term to avoid rapid switching between modes (chattering). Therefore, three goals may be defined at the start of the objective function development, as: 1) CO₂ control: follow set point of CO₂ in the cabin 13; 2) O₂ control: follow set point of O₂ in the cabin 13; and 3) Chattering control: avoid excessive switching.

The resulting NLP may take the following form with a weighted objective function:

$$Minimize {w}_{1} {\sum }_{i ∈ I} {\sum }_{fe ∈ FE , cp ∈ CP} {( {y}_{C} ( {CO}_{2} , i , fe , cp ) - {y}_{C}^{*} ( {CO}_{2} ) )}^{2} + {w}_{2} {\sum }_{i ∈ I} {\sum }_{fe ∈ FE , cp ∈ CP} {( {y}_{C} ( {O}_{2} , i , fe , cp ) - {y}_{C}^{*} ( {O}_{2} ) )}^{2} - {w}_{3} {\sum }_{i ∈ I} T ( i ) \qquad ( 33 )$$

Subject to constraints (16) to (32). The physical restrictions of the system may define system parameters and limits on the control and manipulated variables (Tables 2 and 3). Together, they may define controller feasible space. The initial conditions (Table 4) and model parameters (Table 5) may also be defined for the NMPC controller. The control problem horizon may be chosen to be 4 quarter cycles (i.e., effectively one full cycle).

TABLE 2
SYSTEM PARAMETERS

| Name | Description | Values |
|---|---|---|
| r_{ads}(j, CO₂) | Rate of adsorption of adsorber j (g/hr) | 166.28 |
| r_{des}(j, CO₂) | Rate of desorption of adsorber j (g/hr) | 181.43 |
| r_{C}(CO₂) | Rate of CO₂ generation (4 crew) in the | 152.72 |
| | cabin (g/hr) | |
| −r_{C}(O₂) | Rate of O₂ consumption (4 crew) in the | 127.6 |
| | cabin (g/hr) | |
| y_{C}*(CO₂) | set point (in % mass fraction) of cabin | 0.76 |
| | CO₂level | |
| y_{C}*(O₂) | set point (in % mass fraction) of cabin O₂ | 23.2 |
| | level | |

TABLE 3
PHYSICAL BOUNDS

| Name | Description | Values |
|---|---|---|
| Q^{U}(CO₂, j) | CO₂ uptake limit (solid phase) of | 498.95 |
| | adsorber j (g) | |
| Q_{A}^{U}(CO₂) | CO₂ storage limit of accumulator (g) | 45000 |
| V_{C} | Volume of the cabin (m³) | 25 |
| Vⱼ | Volume of adsorber j (m³) | 0.4 |
| y_{C}^{L}(CO₂), y_{C}^{U}(CO₂) | Bounds on cabin CO₂ level (% mass | 0.59, 1.05 |
| | fraction) | |
| y_{C}^{L}(O₂), y_{C}^{U}(O₂) | Bounds on cabin O₂ level (% mass | 22.5, 25.4 |
| | fraction) | |
| ν₁^{L}, ν₁^{U} | Bounds on volumetric flow in | 30, 50 |
| | stream 1 (g/m³) | |
| ν₂^{L}, ν₂^{U} | Bounds on volumetric flow in | 0.1, 10 |
| | stream 2 (g/m³) | |
| \dot{m}^{U}(CO₂) | Upper bound of CO₂ make-up stream | 80 |
| | (g/hr) | |
| \dot{m}^{U}(O₂) | Upper bound of O₂ make-up stream | 80 |
| | (g/hr) | |

TABLE 4
INITIAL CONDITIONS

| Name | Description | Values |
|---|---|---|
| ρ_{C}⁰(c, i₀, 1) | Initial component densities in the | CO₂ = 12.07 |
| | cabin at start (g/m³) | O₂ = 279.35 |
| | | Inert = 911.87 |
| ρ_{C}⁰(c, i₀, 1, 1) | Initial component densities in | CO₂ = 12.07 |
| | adsorber A (j = 1) at start (g/m³) | O₂ = 279.35 |
| | | Inert = 911.87 |
| ρ_{C}⁰(c, i₀, 2, 1) | Initial component densities adsorber | CO₂ = 2.56 |
| | B (j = 2) at start (g/m³) | O₂ = 410 |
| | | Inert = 1269 |
| Q⁰(CO₂, i₀, 1, 1) | Initial mass (solid phase) of CO₂ in | 0 |
| | adsorber A (j = 1) (g) | |
| Q⁰(CO₂, i₀, 2, 1) | Initial mass (solid phase) of CO₂ in | 250 |
| | adsorber B (j = 2) (g) | |
| Q_{A}⁰(CO₂, i₀, 1) | Initial mass of CO₂ in the | 20000 |
| | accumulator (g) | |

TABLE 5
MODEL PARAMETERS

| Name | Description | Values |
|---|---|---|
| N_{FE} | Number of finite elements within a | 10 |
| | quarter-cycle time length | |
| N_{CP} | Number of collocation points within | 3 |
| | each finite element | |
| M | Number of quarter cycles under | 4 |
| | consideration for NMPC | |
| T_{AS}^{L}, T_{AS}^{U} | Bounds on quarter-cycle time length for | 0.03, 0.2 |
| | air-save mode (hr) | |
| T_{D}^{L}, T_{D}^{U} | Bounds on quarter-cycle time length for | 0.03, 1.0 |
| | desorb mode (hr) | |
| ρ^{L}(CO₂), ρ^{U}(CO₂) | Minimum and maximum total bed | 30, 40 |
| | concentration at the end of Air-save | |
| | mode (gm/m³) | |

The NLP optimization formulation may be modeled using AMPL and solved using CONOPT. This NLP model (the controller) may be coupled with a MATLAB® model of the VCCR system (a simulator) so that the control actions obtained after solving the NLP model may be used to simulate the system in time.

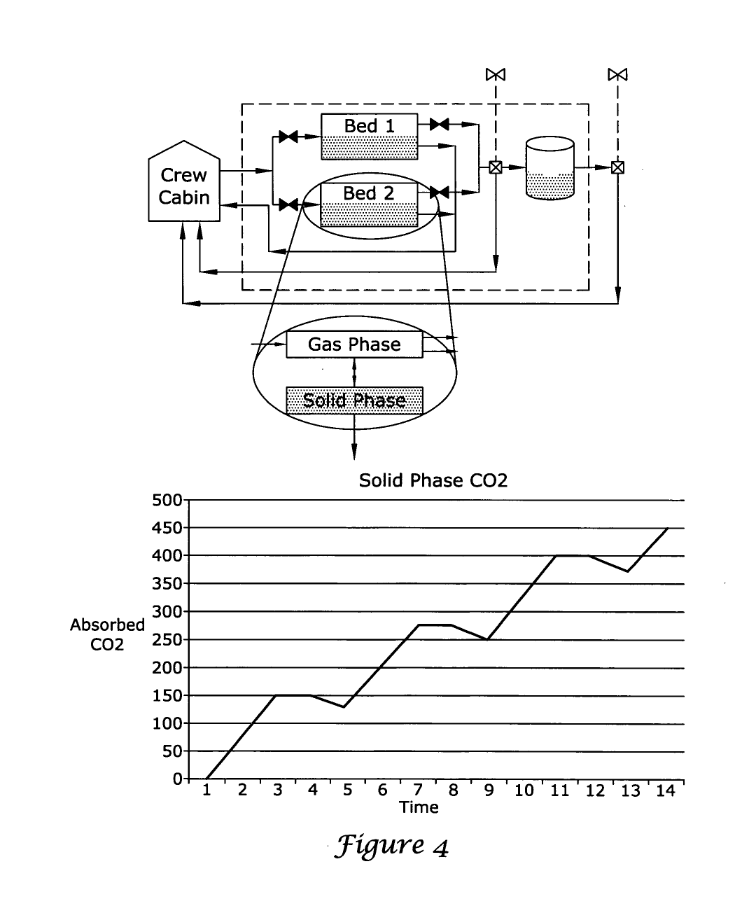

The component profiles obtained by simulating the VCCR-NMPC system may show a rapid build-up of carbon dioxide in the adsorber bed solid phase, across NMPC problem horizons, as shown in FIG. 4. (FIG. 4 shows a bed solid phase profile with only first three terms in the objective.) This build-up may be primarily caused by NMPC solutions exhibiting insufficient desorption quarter-cycle duration in the beds 11 and 12, in any single NMPC invocation with a limited four quarter-cycle horizon view. It is clear from FIG. 3 that the system may spend a greater amount of time in adsorb than in desorb. While the desorb rate is higher than the adsorb rate, the system may need to spend sufficient time desorbing to prevent a run-away to solid phase saturation in the beds. Thus, when one of the beds 11 or 12 is undergoing adsorb, there may be a physical motivation for the other bed to spend a higher fraction of this time interval in desorb, over air-save. The third term in the objective function (33) does not necessarily discriminate between desorb and air-save steps. As such, there may be no driver in the NMPC for cleaning up the beds, to ensure that future NMPC invocations are left with sufficient capacity of adsorption. This limited horizon control calculation may eventually push the beds 11 and 12 towards saturation, and result in system failure. To counter this effect, a term relating to a desorption driver may be added in the objective function:

$$- {w}_{4} {\sum }_{( i , j ) ∈ {B}_{D}} {( Q ( {CO}_{2} , i , j , {N}_{FE} , {N}_{CP} ) - {Q}^{0} ( {CO}_{2} , i , j ) )}^{2} \qquad ( 34 )$$

This term may seek to maximize the clean-up of CO₂ from the adsorber bed solid phase, over the desorb step duration. The summation may apply only to set BD. It may augment the aspects of the NMPC objective function, by ensuring that future NMPC invocations have adequate capacity of adsorption left in the adsorber beds 11 and 12.

With the new objective function, the NMPC solutions may exhibit longer desorb quarter-cycles that drive carbon dioxide out of the bed solid phase. But there may be no driver in the objective function to motivate a large enough volumetric flow rate, v₂, which transports the CO₂ into the accumulator 14 in the desorb step. As a result, the desorbed CO₂ may remain in the gas phase of the adsorber bed, and get recycled into the crew cabin 13 in the subsequent adsorb and air-save steps, raising the CO₂ concentrations to higher levels, and finally to failure. To overcome this defect, another term relating to a CO₂ driver may be added in the objective function:

$$- {w}_{5} {\sum }_{i ∈ {I}_{D}} {Q}_{A} ( {CO}_{2} , i , {N}_{FE} , {N}_{CP} ) \qquad ( 35 )$$

This term may seek to maximize the amount of CO₂ in the accumulator, by the end of the desorb steps (regardless of bed identity). It ensures removal of the desorbed CO₂ from the fluid phase of the adsorber beds by transporting it to the accumulator 14.

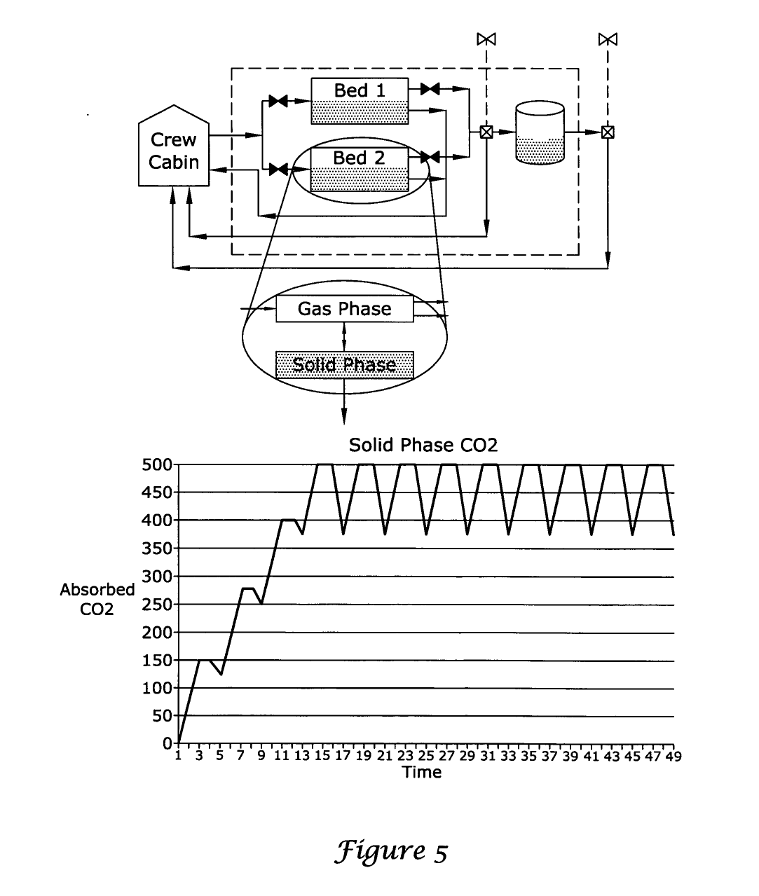

The augmented objective function may help the NMPC formulation in achieving a nominally stable cyclic steady state in bed solid phase with safe conditions in the crew cabin 13. But the beds 11 and 12 may operate (oscillate) at high CO₂ solid-phase levels (see FIG. 5, which shows a bed solid phase profile with desorption driver and CO₂ driver terms added to the objective). For a more robust operation, it may be desirable that this oscillation occur at low CO₂ solid-phase levels, so that there is adequate capacity for adsorption in the face of unforeseen disturbances. So another term relating to a low bed CO₂ driver may be added in the objective function.

$$+ {w}_{6} {\sum }_{( i , j ) ∈ {B}_{D}} Q ( {CO}_{2} , i , j , {N}_{FE} , {N}_{CP} ) \qquad ( 36 )$$

This term may seek to minimize the absolute amount of solid phase loading of CO₂ by the end of the desorb step. This term may be is subtly different from the term in (34), which seeks to maximize the difference in the solid phase loading of CO₂, over the entire duration of the desorb step.

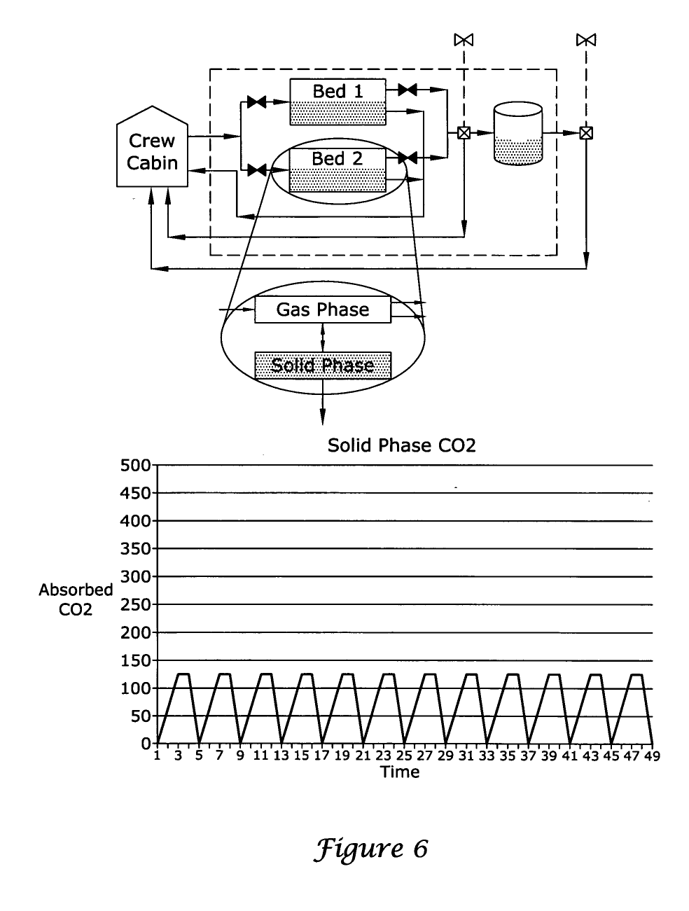

The above steps may conclude the objective function engineering done to obtain satisfactory performance from the NMPC formulation. The resulting cyclic steady state solution is shown in FIG. 6. (FIG. 6 shows the bed solid phase CO₂ profiles (notional) with the complete objective function including all six terms; that is, it is a bed solid phase profile with a low bed CO₂ driver term added to the objective function.) Consequently, the NMPC objective function may take the following form:

$$Minimize \\ {w}_{1} {\sum }_{i ∈ I} {\sum }_{fe ∈ FE , cp ∈ CP} {( {y}_{C} ( {CO}_{2} , i , fe , cp ) - {y}_{ C}^{*} ( {CO}_{2} ) )}^{2} + {w}_{2} {\sum }_{i ∈ I} {\sum }_{fe ∈ FE , cp ∈ CP} {( {y}_{C} ( {O}_{2} , i , fe , cp ) - {y}_{ C}^{*} ( {O}_{2} ) )}^{2} - {w}_{3} {\sum }_{i ∈ I} T ( i ) - {w}_{4} {\sum }_{c = {CO}_{2}} {\sum }_{( i , j ) ∈ {B}_{D}} {( Q ( c , i , j , {N}_{FE} , {N}_{CP} ) - {Q}^{0} ( c , i , j ) )}^{2} - {w}_{5} {\sum }_{c = {CO}_{2}} {\sum }_{( i ) ∈ {I}_{D}} {Q}_{A} ( c , i , {N}_{FE} , {N}_{CP} ) + {w}_{6} {\sum }_{c = {CO}_{2}} {\sum }_{( i , j ) ∈ {B}_{D}} Q ( c , i , j , {N}_{FE} , {N}_{CP} ) \qquad ( 37 )$$

Thus, the multi-objective NMPC formulation may be defined as objective (37) subject to constraints (16)-(32) and physical bounds on control inputs.

The multi-objective NMPC optimization formulation may require tuning of the weights for the six terms that occur in the objective function. The tuning exercise may carried out in two steps, first, taking into account the typical magnitudes of the contributions of the six terms to the objective, and second, factoring the relative importance of these goals. The CO₂ concentration control may be chosen as the most important goal. The performance of the controller with the tuned weights may be studied with a nominal initial condition of the system. The tuned weights of the objective terms are listed in Table 6.

The “baseline” tuning of weights may give good performance on all six objectives. It should be noted that, regardless of the actual choice of the weights in the objective function, the safety requirements may be inherently satisfied in any feasible/optimal solution to the nonlinear program, as these appear as hard constraints in the formulation. In the presence of appropriately chosen weights in the objective, the controller may seek qualitatively better solutions, in addition to just feasibility—say, with the appropriate weight on the low bed CO₂ driver, the controller may maintain low average CO₂ levels in the bed solid phase, and leads to long, stabilized, cycle-times.

TABLE 6
TUNED WEIGHTS FOR OBJECTIVE TERM

| Name | Description | Values |
|---|---|---|
| W₁ | Weight for CO₂ control | 10 |
| W₂ | Weight for O₂ control | 0.05 |
| W₃ | Weight for chattering control | 1 |
| W₄ | Weight for desorption driver | 0.1 |
| W₅ | Weight for CO₂ driver | 0.01 |
| W₆ | Weight for low Bed CO₂ driver | 1 |

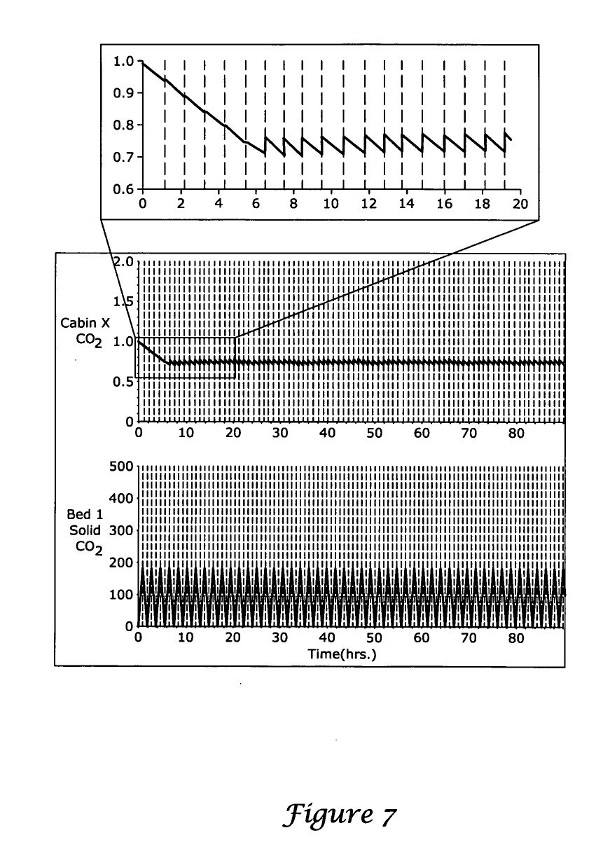

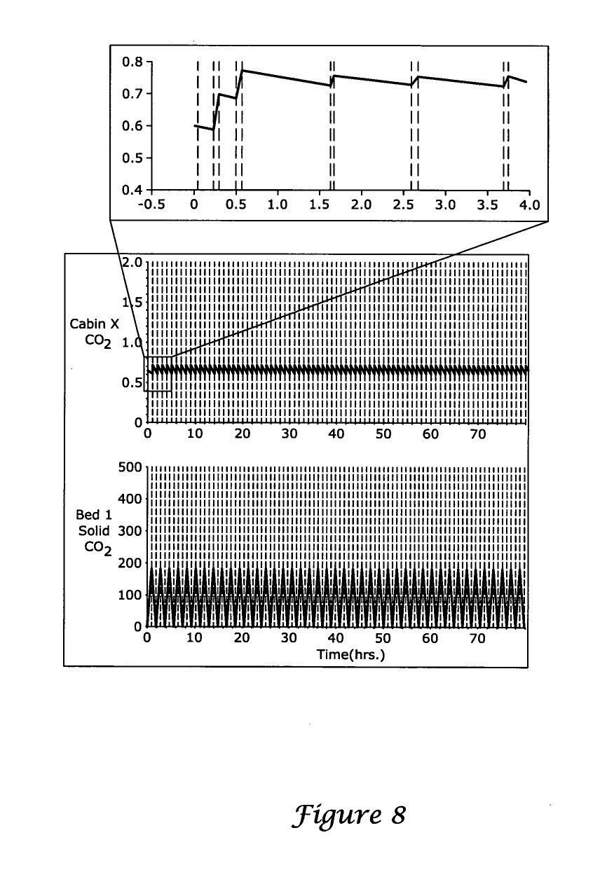

The controller performance may be presented on two off-nominal conditions: 1) Cabin 13 at very high CO₂ concentration; and 2) Cabin 13 at very low CO₂ concentration. A primary goal is to study the effect of such extreme scenarios on the performance of the controller. For these two cases, the VCCR-NMPC system may be simulated for about 160 hours. FIGS. 7 and 8 show the carbon dioxide concentration (in percentage mass fractions) profiles for the two cases. (FIG. 7 shows NMPC controller performance with high initial CO₂ in the crew cabin 13, and FIG. 8 shows NMPC controller performance with low initial CO₂ in the crew cabin.) The controller may take the cabin CO₂ concentrations to the desired set-point and maintain it around the set-point. A stable cyclic pattern may be observed in solid phase concentration of both adsorber beds with a 5 minute air-save mode and a 1 hour desorb mode. Thus, the NMPC may demonstrate effective controller performance in the face of off-nominal initial concentrations in the cabin 13.

To highlight the benefits in performance attainable through the systematic NMPC design procedure note in this specification, its performance may be contrasted with a simple feedback controller. The controller may consists of proportional-integral (PI) rules for regulating O₂ and CO₂ levels in the cabin 13, heuristic feedback laws for controlling volume flow rates and a switching rule. The PI laws regulating cabin O₂ and CO₂ levels through compensatory supplies respectively from the OGS 16 and the accumulator 14 may be as follows:

$$\dot{m} ( {O}_{2} ) = [ {k}_{p} + \frac{{k}_{i}}{s} ] ( {ρ}_{C}^{ref} ( {O}_{2} ) - {ρ}_{C} ( {O}_{2} ) ) \\ \dot{m} ( {CO}_{2} ) = [ {k}_{p} + \frac{{k}_{i}}{s} ] ( {ρ}_{C}^{ref} ( {CO}_{2} ) - {ρ}_{C} ( {CO}_{2} ) ) \qquad ( 35 )$$

where ρ_{C}^{ref}(CO₂)=6 g/m³, ρ_{C}^{ref}(O₂)=285 g/m³ , kₚ=8,kᵢ=9, τ may be a small number for ensuring causality in the implementation. The integrator states may have saturation limits

$$[ \begin{matrix}0 \\ 0\end{matrix} ] and [ \begin{matrix}243.1 \\ 73.1\end{matrix} ]$$

to prevent unachievable control inputs for the CO₂ and O₂ supplies, respectively.

Integral control may be the natural option to track the movement of an unknown variable with the integrator state and regulate its level. The speeds of the control action may be designed such that the control laws are not sensitive to the periodic sudden fluctuations of gas concentrations caused by the beds switching from adsorb to airsave to desorb.

The adsorption and desorption volume flow rates (in effect the control of blower speed for adsorption and pump/compressor speed for desorption) may be controlled by “proportional” feedback:
v₁=40−0.1(ρ_{C}^{ref}(CO₂)−ρ_{C}(CO₂))m³/hr
v₂=5ρ(CO₂j)m³/hr (36)
The rationale for the proportional control may be to keep the blowing/pumping effort proportional to the quantity of CO₂ in the fluid phase, and thus keep the present efforts economical.

Finally, the switching of adsorption from one bed to another may be governed by the following rules:

$${S}_{k} = \{ \begin{matrix}1 & if ( {S}_{k - 1} = 1 ) ⋀ \\ & [ Q ( {CO}_{2} , 1 ) < {Q}^{U} ( {CO}_{2} , 1 ) ⋀ Q ( {CO}_{2} , 2 ) > 0 ] \\ 2 & if ( {S}_{k - 1} = 1 ) ⋀ \\ & [ Q ( {CO}_{2} , 1 ) = {Q}^{U} ( {CO}_{2} , 1 ) ⋁ Q ( {CO}_{2} , 2 ) = 0 ] \\ 2 & if ( {S}_{k - 1} = 2 ) ⋀ \\ & [ Q ( {CO}_{2} , 2 ) < {Q}^{U} ( {CO}_{2} , 2 ) ⋀ Q ( {CO}_{2} , 1 ) > 0 ] \\ 1 & if ( {S}_{k - 1} = 2 ) ⋀ \\ & [ Q ( {CO}_{2} , 2 ) = {Q}^{U} ( {CO}_{2} , 2 ) ⋁ Q ( {CO}_{2} , 1 ) = 0 ]\end{matrix} \qquad ( 37 )$$

where Sₖ=1 plus adsorption into bed 11 and Sₖ=2 implies adsorption into bed 12. The switching law may cover all possible cases and ensure that energy is not spent in trying to adsorb more into a saturated bed, or to desorb more CO₂ away from an empty bed.

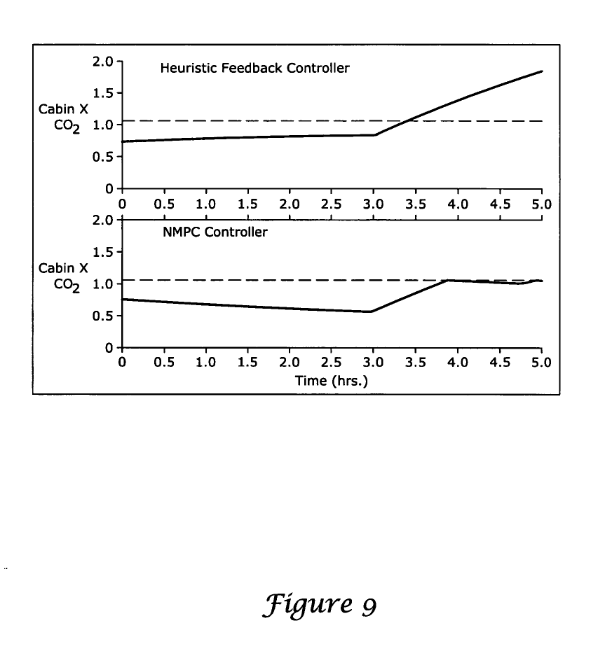

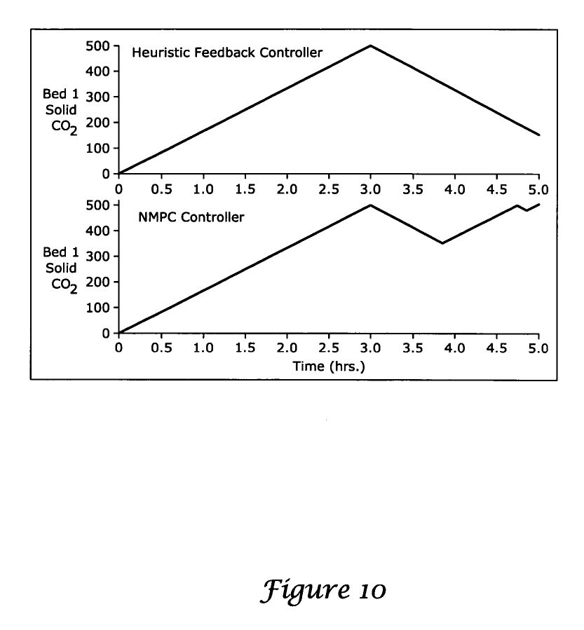

The following involves a comparison of the NMPC controller with a heuristic controller. The critical failure modes in the VCCR system 10 may be single bed failure and degradation of adsorption/desorption rates. For the case where only a single bed is operational, FIG. 9 shows the Cabin CO₂ concentration profile and FIG. 10 shows adsorber bed solid phase CO₂ profile with time. (FIG. 9 shows a comparison of controller performance in the crew cabin 13 with one active adsorber—single side operation, and FIG. 10 shows a comparison of controller performance in adsorber Bed 11 with one active adsorber—single side operation.) From the profiles, it appears that the VCCR-NMPC system can sustain for close to 5 hours, before the concentrations of O₂ and CO₂ hit the permissible limits. In contrast to this behavior, the heuristic feedback controller appears able to sustain the system to 3.5 hours. The look-ahead capabilities of the model-predictive NMPC controller may allow it to cope better in the face of failure. As seen in FIG. 9 and FIG. 10, while the NMPC controller and the heuristic-feedback controller may operate the same in the adsorb-mode, the NMPC controller may terminate the desorb mode just correctly with the right volumetric flow rates, so that overall feasibility of the system is maintained for a longer duration.

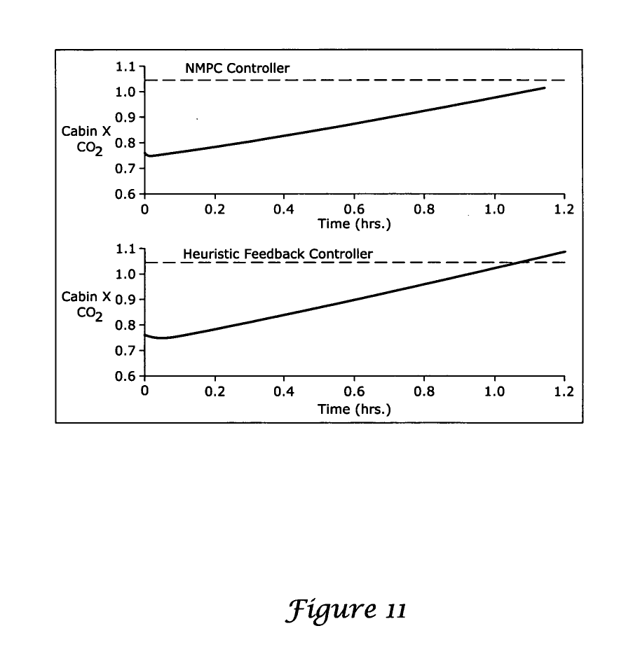

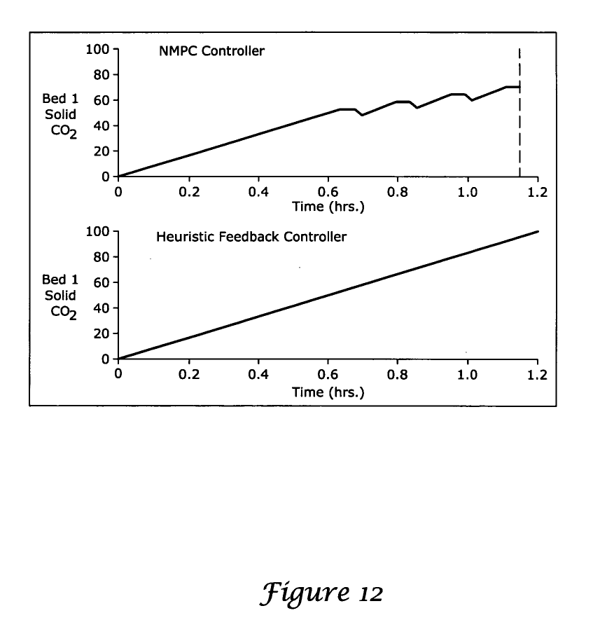

When the rates of adsorption and desorption reduce to half of their design values, the carbon dioxide adsorption rate in both adsorber beds 11 and 12 may fall below the generation rate in the cabin 13 and the crew cabin starts accumulating CO₂ rapidly. As a result, the VCCR system 10 may sustain with an optimal controller for approximately 1.2 hours, before CO₂ concentration reaches the upper limit in the cabin 13. (See FIGS. 11 and 12, where FIG. 11 shows a comparison of controller performance in the crew cabin with degraded adsorbers (half adsorb/desorb rates), and FIG. 12 shows a comparison of controller performance in adsorber bed 11 with degraded adsorbers (half adsorb/desorb rates).)

The NMPC may give rise to a qualitatively different profile due to its look-ahead capability. Both controllers may exhibit similar performance with respect to time of failure, since this is a system limitation and no controller will likely be able to maintain safety in this extreme situation. While the simulations may illustrate safe performance under nominal and off-nominal conditions, they do not prove safe performance. However, guarantees of safe performance may be provided for both the controllers.

An adaptation of MPC may be provided for a nonlinear, hybrid dynamic system. The present approach may view the NMPC horizon in units of time-intervals that the system spends in various hybrid modes, and apply collocation on finite elements to describe the evolution of the nonlinear dynamic system within each time-interval (mode). Such a view may appear general enough to address a broad class of nonlinear hybrid systems, which exhibit a structured pattern of switching across modes. There may be a systematic method of objective function engineering for the NMPC regulation problem to address long-term, nominal stability for a fixed, short horizon of control computation.

There may be two approaches used for safety verification of the controlled hybrid dynamical system. The objective of verification is to show that control of the variable configuration carbon dioxide removal (VCCR) system maintains safe concentrations of carbon dioxide and oxygen in the crew cabin. First, a sum-of-squares programming approach to nonlinear hybrid system safety verification may be used. The safe performance of the heuristic controller may be verified by constructing a so-called barrier certificate using the sum of squares decomposition. First, one may successfully compute barrier functions for an intrinsically hybrid system with high dimensional continuous dynamics. Safety verification of the Model Predictive Controller may be performed for the same system using techniques from the statistical learning theory. This approach may be based on deriving tight Vapnik-Chervonenkis-style (VC) generalization bounds for binary classifiers with weighted loss. Simulations using these bounds may be defined to statistically verify the safe performance of a nonlinear model predictive controller for the air recovery system, under off-nominal operating conditions and failure scenarios. These bounds may be used to specify a safe operating envelope for this system under extreme operating conditions. The two different approaches may give consistent results.

Safety verification for systems exhibiting hybrid dynamics is a significant area. Hybrid dynamical systems provide a framework for several real world applications, especially those that involve the control of systems of systems along with the concomitant hierarchical decision processes. The analysis of these systems may be initiated primarily in the theoretical computer science community. Several methods may be developed to handle systems with large scale discrete dynamics and simple continuous dynamics. These approaches may break down in the face of nonlinear continuous dynamics combined with complex decision rules. Control synthesis tools may be provided for hybrid systems whose continuous dynamics are linear and time invariant. The system here may be the variable configuration carbon dioxide removal (VCCR) system, a life support system test-bed which may have both continuous nonlinear dynamics and switching rules, and a guarantee of safe performance for the controlled system. The hybrid nature of the system may arise from the different modes in which it has to be operated. A SIMULINK® model of the detailed dynamics of the system may serve as a test bed for our control strategies.

The desired safety criteria for this system are that the concentrations of the ambient gases (CO₂ and O₂) in the crew cabin may remain between the specified upper and lower bounds at all times. Of particular significance is the ability of the controller to maintain crew cabin concentrations under off-nominal operating conditions: high initial concentration of carbon dioxide in the cabin; high initial carbon dioxide hold up in one of the adsorber beds; lower adsorption and desorption rates; and failure conditions e.g., when one bed is completely out of commission. Safe performance of the controlled system under the two control designs-heuristic feedback controller and Nonlinear Model Predictive Controller (NMPC)—may be verified.

For safety verification of the heuristic feedback controller, the barrier certificate method may be used. A barrier function may be may be constructed to show that trajectories of the closed loop control system do not go into unsafe operating regions, for a given set of initial conditions (fairly large) in cabin concentration, and also for degraded system operation. The computation (showing the existence) of barrier functions may be performed with a sum of squares decomposition and semi-definite programming methods. The method may be much more general than standard Lyapunov analysis or computation of region of attraction, and fits naturally resulting in the fact that one does not have an analytic characterization of equilibrium sets of the controlled system. The present approach may be compute barrier functions for an intrinsically hybrid system with high dimensional continuous dynamics. It may provide for safety verification of systems where switching control laws are already operational.

An alternate approach to verification may be based on statistical learning theory (SLT). SLT may provide a framework used to compute a safe operating envelope for a system, with some statistical guarantees on the safety bounds. The verification problem in the SLT framework may be presented as a binary classification problem, and be used to determine the “best” classifier that can correctly categorize input conditions as—“within the SOE” or “outside the SOE”. This verification approach may use results from statistical learning theory to determine the classifier that minimizes misclassification errors (i.e., by eliminating false positive classification errors which result in severe safety repercussions) and to minimize false negative errors (which result in a conservative, inefficient performance of the controller), and to derive the classifier using the least possible number of training samples, while at the same time maintaining desired guarantees of performance.

This approach may be used to verify the safety performance of the NMPC. This approach may be suitable for solving the NMPC safety performance verification problem, as the solutions of non-convex optimization problems are not available in closed analytic form. This approach may also be useful in cases where neither analytical approaches to verification nor exhaustive search of the entire state space are practical. This approach may provide a good middle ground by limiting the number of samples required for verification, while at the same time, maintaining statistical guarantees.

The dynamic model used for safety verification may be put in a format suitable to construction of barrier certificates using sum of squares tools.

The equations that describe the state evolution (i.e., the concentrations of CO₂, O₂ and inerts in the beds and cabin) may be different for the air-save, adsorb and desorb processes. They may be however simple mass balance equations. A notation convenient for use in sum of squares programming may include: x₁=ρ_{C}(CO₂), the concentration of CO₂ in the cabin; x₂=ρ_{C}(CO₂,1), x₃=ρ_{C}(CO₂,2), the concentrations of CO₂ in Bed 1 and Bed 2, respectively; and x₄=\dot{m}_{CO}_{₂}, the make-up mass flow of CO₂ in the cabin. Similarly, Further notation may include: z₁=ρ_{c}(O₂), O₂ concentration in the cabin; z₂=ρ(O₂,1) and z₃=ρ(O₂,2) the concentrations of O₂ in the two beds; and z₄=\dot{m}_{O}_{₂} the make-up mass flow of O₂ in the cabin. All the above quantities are in units of g/m³.

The control variables may be the volumetric flow rates of the two streams and the make-up mass flow rate of the CO₂ and O₂ streams. Control laws may include the following: 1) Volumetric flow rate from the cabin to the bed undergoing adsorption, v_{ad}=v_{ad,n}+kₚ^{ads}(x₁−x_{1,r}), where v_{ad,n} and kₚ^{ads} are constants and x_{1,r} is a reference value for the desired concentration of CO₂ in the cabin; 2) Volumetric flow rate from the cabin to the bed undergoing air-save is a constant, vₐₛ; and 3) Volumetric flow rate from the cabin to the bed undergoing desorption, v_{des,i}=kₚ^{des}xᵢ, i ∈ {2,3}, where kₚ^{des} is a constant.

The make-up mass flow rate of CO₂ in the cabin may given by a PI controller. In the frequency domain, there may be:

$$\begin{matrix}{x}_{4} ( s ) = [ {k}_{p} + \frac{{k}_{I}}{s} ] [ {x}_{1} ( s ) - {x}_{1 , r} ] \\ = [ \frac{{k}_{p} s + {k}_{l}}{s} ] [ {x}_{1} ( s ) - {x}_{1 , r} ]\end{matrix}$$

Going back to the time domain, there may be:
\dot{x}₄=kₚ\dot{x}₁+k₁(x₁−x_{1,r})
The make-up mass flow rate of O₂ in the cabin may also be given by a PI controller of the similar structure as for CO₂,
\dot{z}₄=kₚ\dot{z}₁+k₁(z₁−z_{1,r})
where z_{1,r} is a reference point for the desired O₂ concentration in the cabin. The system may switch between 4 different modes, the dynamic equations of which are described below.

Mode 1 may include adsorber 1 adsorbing, and adsorber 2 in air-save. In this first cycle, Bed 11 is adsorbing CO₂ from the cabin. Bed 12 has just finished this cycle, and the CO₂-lean air in the bed may be pumped back in the cabin, before the CO₂, that was accumulated in the bed is desorbed and removed. The equations describing the system in this phase may be given by:
V_{c}\dot{x}₁=[v_{ad,n}+kₚ^{ads}(x₁−x_{1,r})](x₂−x₁)+v_{as,n}x₃+r_{c}(CO₂)+x₄
V₁\dot{x}₂=−[v_{ad,n}+kₚ^{ads}(x₁−x_{1,r})](x₂−x₁)−r_{ads}(CO₂,1)
V₂\dot{x}₃=−v_{as,n}x₃
\dot{x}₄=kₚ\dot{x}₁+k₁(x₁−x_{1,r})
V_{c}\dot{z}₁=[v_{ad,n}+kₚ^{ads}(x₁−x_{1,r})](z₂−z₁)+v_{as,n}z₃+r_{c}(O₂)+z₄
V₁\dot{z}₂=−[v_{ad,n}+kₚ^{ads}(x₁−x_{1,r})](z₂−z₁)
V₂\dot{z}₃=−v_{as,n}z₃
\dot{z}₄=kₚ\dot{z}₁+k₁(z₁−z_{1,r})
Mode 2 may include adsorber 1 adsorbing, and adsorber 2 in desorbing. In this mode, Bed 1 is still adsorbing, but Bed 12 has pumped all CO₂-free gas in the cabin and is now desorbing. The switching from Mode 1 to Mode 2 may be done when the concentration of CO₂ in Bed 12 falls below a certain level, x₃≦x^{c}.
V_{c}\dot{x}₁=[v_{ad,n}+kₚ^{ads}(x₁−x_{1,r})](x₂−x₁)+r_{c}(CO₂)+x₄
V₁\dot{x}₂=−[v_{ad,n}+kₚ^{ads}(x₁−x_{1,r})](x₂−x₁)−r_{ads}(CO₂,1)
V₂\dot{x}₃=−kₚ^{des}x₃²+r_{des}(CO₂,2)
\dot{x}₄=kₚ\dot{x}₁+k₁(x₁−x_{1,r})
V_{c}\dot{z}₁=[v_{ad,n}+kₚ^{ads}(x₁−x_{1,r})](z₂−z₁)+r_{c}(O₂)+z₄
V₁\dot{z}₂=−[v_{ad,n}+kₚ^{ads}(x₁−x_{1,r})](z₂−z₁)
V₂\dot{z}₃=−kₚ^{des}x₃z₃
\dot{z}₄=kₚz\dot{z}₁+k₁(z₁−z_{1,r})

Mode 3 may include adsorber 2 adsorbing, and adsorber 1 in air-save. This mode is the same as Mode 1, under the intuitive symmetry. Switching from Mode 2 to Mode 3 is done when both adsorption and desorption processes are complete. Because of the saturation in these processes, the transition is done through an intermediate stage, as will be discussed later on.

Mode 4 may include adsorbeb 2 adsorbing and adsorber 1 desorbing. This mode is the same as Mode 2 modulo the implied symmetry. The equations for Modes 3 and 4 are identical to those of Modes 1 and 2, respectively, with the roles of the two beds reversed.

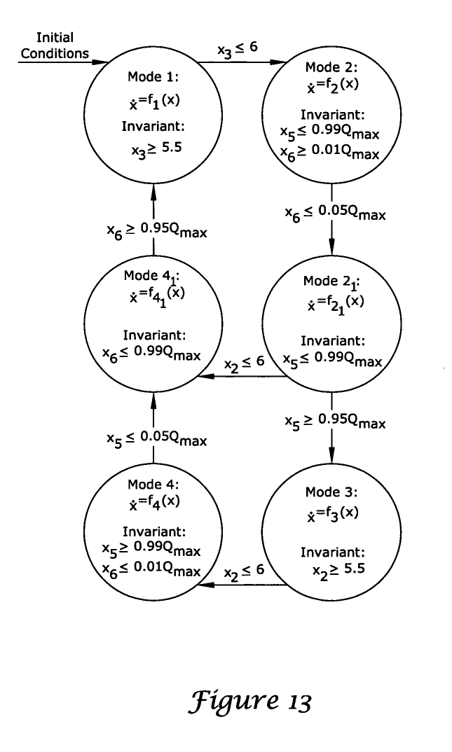

The parameters that appear in the previous equations and physical constraints are shown in the present description. Coefficients of the switching PI controller appear in Table 7 The controller switching rules are as per FIG. 13. The system may be initialized in Mode 1, at a configuration in which the initial concentration of CO₂ in the cabin and Bed 1 is about atmospheric (9.13 g/m³) and in Bed 12 is below atmospheric (2.56 g/m³). Bed 11 is in adsorber mode and Bed 12 is in air-save mode.

In the next mode, air-save may end and Bed 12 start desorbing. Switching from Mode 1 to Mode 2 may then happen when the level of CO₂ in Bed 12 has reduced significantly. This level may be set to 5.5 g/m³.

TABLE 7
CONTROLLER COEFFICIENT VALUES

| Control | |
|---|---|
| Parameter | Value |
| k_{I} | −9 |
| kₚ | −8 |
| k^{ads}ₚ | −0.1 |
| k^{des}ₚ | 5 |

For the switching from Mode 2 to Mode 3, the deciding factor may be the level of CO₂ that has been adsorbed in Bed 1, i.e., whether it has saturated, and whether the level of CO₂ is almost zero in Bed 12, which is desorbing.

The solid phase concentration for Beds 11 and 12, x₆ and x₇ respectively, may be calculated as follows:

| | |
|---|---|
| Mode 1: | \dot{x}₅ = r_{ads}(CO₂, 1) |
| | \dot{x}₆ = 0 |
| Mode 2: | \dot{x}₅ = r_{ads}(CO₂, 1) |
| | \dot{x}₆ = −r_{des}(CO₂, 2) |
| Mode 3: | \dot{x}₅ = 0 |
| | \dot{x}₆ = r_{ads}(CO₂, 2) |
| Mode 4: | \dot{x}₅ = −r_{des}(CO₂, 1) |
| | \dot{x}₆ = r_{ads}(CO₂, 2) |

Switching to Mode 3 from Mode 2 may occur when both of the following items occur. Bed 11 has saturated, i.e., it cannot adsorb more CO₂; and Bed 12 cannot desorb further.

An alternative would be to switch from Mode 2 to Mode 3 based on the fluid CO₂ levels in the adsorbers. These levels may be judiciously chosen so that they would correspond to the above scenarios. Switching from Mode 3 to Mode 4 and from Mode 4 to Mode 1 can be done in a symmetric manner.

As the adsorption happens at a much slower rate than desorption, the bed that is desorbing will reach saturation before the bed that is adsorbing. This may necessitate the introduction of two intermediate modes. These are depicted in FIG. 13.

The control laws in the equations describing the dynamics in the various modes may be functions on the concentration of CO₂ in the cabin and the two beds. The flow rate of the two streams connecting the cabin with the two beds may depend on the discrepancy between the desired and actual level of CO₂ in the cabin. Moreover, the switching strategy may also be a function of the CO₂ concentration in the beds. The feedback on the O₂ concentration may be a “follower” of this strategy, and it may be the only link between O₂ and CO₂ dynamics. There may be hybrid system safety verification using the sum of squares decomposition. The task may be to verify the safety of the system, in particular to ascertain that the levels of CO₂ and O₂ do not vary outside the required levels. To do this, first the system may be modeled as a finite automaton shown in “The Algorithmic Analysis of Hybrid Systems,” by R. Alur, C. Courcoubetis, N. Halbwachs, T. A. Henzinger, P.-H. Ho, X. Nicolin, A. Oliviero, J. Sifakis, and S. Yovine, in Theoretical Computer Science, 138:3-34, 1995. To handle the verification problem, one may consider the setup in “Safety Verification of Hybrid Systems Using Barrier Certificates,” by S. Prajna and A. Jadbabaie, in Hybrid Systems: Computation and Control, LNCS 2293, pages 477-492. Springer-Verlag, 2004; and solve it using the tools in “SOS-TOOL—Sum of Squares Optimization Toolbox, User's Guide,” by S. Prajna, A. Papachristodoulou, and P. A. Parrilo at http:/ /www.cds.caltech.edu/ sostools and http:/ /www. aut.ee.ethz.ch/ ˜parrilo/sostools, 2002.

The continuous state of a hybrid dynamical system may evolve according to a set of continuous time differential equations determined by its discrete states, which in turn are governed by a discrete event process (such as a finite automaton). A hybrid system may be a tuple H=(χ,L,X₀,I,F,T) with the following components. χ⊂ [symbol] ″ is the continuous state-space; L is a finite set of locations; the overall state-space of the system is X=L×χ, and a state of the system is denoted by (l,x) ∈ L×χ; X₀ ⊂ X is a set of initial states; I:L→2^{χ} is the invariant, i.e., the set of all possible continuous states while at location l; F:X→2^{″} is a set of vector fields, one of each location; and T⊂X×X is a relation describing discrete transitions between two locations, when a guard relation is satisfied.

The system may evolve from the initial conditions in the set X₀, and after a sequence of continuous flows and discrete transitions that are described by the map T. A set of unsafe states may be denoted Xᵤ ⊂ X. In addition, for each location l ∈ EL, one may define the set of initial and unsafe continuous states as Init(l)={x ∈ X:(l,x) ∈ X₀}, Unsafe(l)={x ∈ X:(l,x)∈Xᵤ}. To each tuple (\dot{l},l) ∈ L×L with \dot{l}≠l, one may associate a guard set Guard(\dot{l},l)={\dot{x} ∈ X:((\dot{l},\dot{x}),(l,x))∈T} for some x∈X.

The safety verification problem may aim in deciding whether the system can reach a set of unsafe states Xᵤ ⊂ X. To answer this question, one may use a, Barrier Certificates (See “Structured Semi-Definite Programs and Semi-Algebraic Geometry Methods in Robustness and Optimization,” by P. A. Parrilo, Ph.D. Thesis, California Institute of Technology, Pasadena, Calif., 2000, at http://www. control.ethz.ch/ ˜parro;p/pubs/index.html.

One may set forth a Theorem 1. Let the hybrid system H=(χ,L,X₀,I,F,T) and the unsafe set Xᵤ be given. Suppose there exists a barrier certificate, i.e., a collection {Bₗ(x)} of functions Bₗ(x) for all l ∈ L, each of which may differentiable with respect to its argument and satisfy

$$\begin{matrix}\begin{matrix}{B}_{l} ( x ) > 0 & ∀ x ∈ Unsafe ( l )\end{matrix} & ( 1 ) \\ \begin{matrix}{B}_{l} ( x ) \leq 0 & ∀ x ∈ Init ( l )\end{matrix} & ( 2 ) \\ \begin{matrix}\frac{\partial {B}_{l} ( x )}{\partial x} {f}_{l} ( x ) \leq 0 & ∀ x ∈ I ( l ) such that {B}_{l} ( x ) = 0 and {f}_{l} ⋐ F\end{matrix} & ( 3 ) \\ {B}_{l} ( x ) \leq 0 for some {l}^{′} ∈ L , x ∈ Guard ( {l}^{′} , l ) , {B}_{{l}^{′}} ( x ) \leq 0 & ( 4 )\end{matrix}$$

Then the safety of the hybrid system H may be guaranteed.

A proof may be in the following. Let such a barrier certificate be given and consider a trajectory of the hybrid system from an initial condition (l₀,x₀) ∈ X₀ and the evolution of Bₗ₍ₜ₎[x(t)] along this trajectory. The second condition may assert that Bₗ[x(t)]≦0, and the third and fourth conditions assert that {Bₗ(x)} cannot take positive values. Consequently, any such trajectory may never reach an unsafe (lᵤ,xᵤ) ∈ Xᵤ, where Bₗ_{ᵤ}(xᵤ) is positive according to the first condition. Therefore, the safety of the system may be guaranteed.

The last two conditions in the above theorem appear not to be convex, but the may be relaxed to convex conditions in the following. The following is a proposition 2. Let the hybrid system H=(χ,L,X₀,I,F,T), the unsafe set Xᵤ and some nonnegative constants σ_{l,l′} be given. Suppose there exists a barrier certificate, i.e., a collection {Bₗ(x)} of functions Bₗ(x) for all l ∈ L, each of which may be differentiable with respect to its argument and satisfies (1-2) and

$$\begin{matrix}\begin{matrix}\frac{\partial {B}_{l} ( x )}{\partial x} {f}_{l} ( x ) \leq 0 & ∀ x ∈ I ( l )\end{matrix} & ( 5 ) \\ \begin{matrix}{B}_{l} ( x ) - {σ}_{l , {l}^{′}} {B}_{{l}^{′}} ( x ) \leq 0 & for some {l}^{′} ∈ L , x ∈ Guard ( {l}^{′} , l )\end{matrix} & ( 6 )\end{matrix}$$

Then the safety of the hybrid system H may be guaranteed.

Construction of barrier certificates may not be easy, and even proving that a given barrier certificate satisfies the required conditions may be difficult. However, for systems whose vector fields are polynomial and whose set descriptions are semi-algebraic (i.e., described by polynomial equalities and inequalities), then one may use the sum of squares decomposition and semi-definite programming (see “Semi-Definite Programming,” by SIAM Review, 38(1):49-95, 1996.) to construct polynomial barrier certificates. This procedure may be described in “Safety Verification of Hybrid Systems Using Barrier Certificates,” by S. Prajna and A. Jadbabaie, in Hybrid Systems: Computation and Control, LNCS 2293, pages 477-492. Springer-Verlag, 2004.

In order to proceed, one may obtain descriptions of the unsafe, initial invariant and guard sets as semi-algebraic sets, i.e., they are captured by a vector of polynomial inequalities g_{Unsafe (l)}≦0, g_{Init (l)}(x)≦0, g_{l (l)}(x)≦0, and g_{Guard (l,l′)}(x)≦0. The search for a barrier certificate may then be formulated as a sum of squares optimization problem, given by the following proposition 3. Let the hybrid system H and the descriptions of all the sets I(l), Init(l), Unsafe(l) and Guard(l) be given. Suppose there exist polynomials Bₗ(x), a positive number ε and vectors of sums of square σ_{Unsafe (l)}(x), σ_{Init(l)}(x), σ_{I(l)}(x) and σ_{Guard (l,l′)}(x) and σ_{B}_{ₗ}_{′}(x) such that the following expressions:

$$\begin{matrix}{B}_{l} ( x ) - ɛ + {σ}_{Unsafe ( l )}^{T} ( x ) {g}_{Unsafe ( l )} ( x ) & ( 7 ) \\ - {B}_{l} ( x ) + {σ}_{Init ( l )}^{T} ( x ) {g}_{Init ( l )} ( x ) & ( 8 ) \\ - \frac{\partial {B}_{l} ( x )}{\partial x} {f}_{1} ( x ) + {σ}_{I ( l )}^{T} ( x ) {g}_{I ( l )} ( x ) & ( 9 ) \\ - {B}_{l} ( x ) + {σ}_{{B}_{l}^{′}} ( x ) {B}_{{l}^{′}} ( x ) + {σ}_{Guard ( l , {l}^{′} )}^{T} ( x ) {g}_{Guard ( l , {l}^{′} )} ( x ) & ( 10 )\end{matrix}$$

may be sums of squares for each l,l′ ∈ L², l≠l′. Then Bₗ(x) may satisfy the conditions of theorem 2 and the safety of the system may be guaranteed.

One may construct barrier certificates for the VCCR system. In order to apply the above proposition, one may introduce the initial and unsafe sets, the invariant sets for the various modes and the guard sets as semi-algebraic sets.

The initial conditions may be assumed to be in the following set:
X₀={x∈χ|(x₁−9)²+(x₂−9)²+(x₃−25)²+(x₄−16)²−0.5²≦0, (z₁−280)²+(z₂−280)²+(z₃−280)²+(z₄−80)²−5²≦0, (x₆−20) (x₆−30)≦0, (x₇−220) (x₇−240)≦0}
The unsafe set may be given by:
Xᵤ={x∈χ|(x₁−7.1) (x₁−126)≧0,(z₁−271)(z₁−305)≧0} (11)

If one assumes that the inerts have a concentration of around 913 g/m³, then, in terms of mass fraction percentages, the above unsafe set may corresponds to CO₂ in the range 0.59-1.05% and O₂ in the range 22.5-25.4%.

If one assumes that the system switches between 6 states, the intermediate state 2₁ and 4₁ shown in FIG. 13 take into account the saturations in the beds. In all modes, part of the invariant set may be described by:

$${I}_{com} = \{ x ∈ χ \vert {( {x}_{1} - 9 )}^{2} + {( {x}_{2} - 7 )}^{2} + {( {x}_{3} - 7 )}^{2} + {( {x}_{4} - 16 )}^{2} - {7}^{2} \leq 0 , {( {z}_{1} - 280 )}^{2} + {( {z}_{2} - 280 )}^{2} + {( {z}_{3} - 280 )}^{2} - {40}^{2} \leq 0 , {z}_{4} ( {z}_{4} - 200 ) \leq 0 \}$$

For the various modes, one further has:

$${I}_{1 , p} = \{ x ∈ χ \vert \begin{matrix}5 , 5 - {x}_{3} \leq 0 , {x}_{5} ( {x}_{5} - {Q}_{max} ) \leq 0 , \\ {x}_{6} ( {x}_{4} - {Q}_{max} ) \leq 0\end{matrix} \}$$

$${I}_{2 , p} = \{ x ∈ χ \vert \begin{matrix}{x}_{5} ( {x}_{5} - 0.99 {Q}_{max} ) \leq 0 , \\ ( {x}_{6} - 0.01 {Q}_{max} ) ( {x}_{6} - {Q}_{max} ) \leq 0\end{matrix} \}$$

$${I}_{{2}_{1} , p} = \{ x ∈ χ \vert \begin{matrix}{x}_{5} ( {x}_{5} - 0.99 {Q}_{max} ) \leq 0 , \\ {x}_{6} ( {x}_{6} - 0.01 {Q}_{max} ) \leq 0\end{matrix} \}$$

$${I}_{3 , p} = \{ x ∈ χ \vert \begin{matrix}5.5 - {x}_{2} \leq 0 , {x}_{5} ( {x}_{5} - {Q}_{max} ) \leq 0 , \\ {x}_{6} ( {x}_{6} - {Q}_{max} ) \leq 0\end{matrix} \}$$

$${I}_{4 , p} = \{ \begin{matrix}x ∈ χ \vert ( {x}_{5} - 0.01 {Q}_{max} ) ( {x}_{5} - {Q}_{max} ) \leq 0 , \\ {x}_{6} ( {x}_{6} - 0.99 {Q}_{max} ) \leq 0\end{matrix} \}$$

$${I}_{{4}_{1} , p} = \{ x ∈ χ \vert \begin{matrix}{x}_{6} ( {x}_{6} - 0.99 {Q}_{max} ) \leq 0 , \\ {x}_{5} ( {x}_{5} - 0.01 {Q}_{max} ) \leq 0\end{matrix} \}$$

The invariant set for each mode may then be Iₗ=I_{com}∩I_{l,p}.

Switching between the various modes may occur when the state in the particular mode finds itself in the guard set. The guard sets are depicted in FIG. 13, and reproduced here.
Guard(1,2)={x ∈ χ|x₃−6≦0}
Guard(2,2₁)={x ∈ χ|x₆(x₆−0.05Qₘₐₓ)≦0}
Guard(2₁,3)={x ∈ χ|(x₅−0.95Qₘₐₓ)(x₅−Qₘₐₓ)≦0}
Guard(3,4)={x ∈ χ|x₂−6≦0}
Guard(4,4₁)={x ∈ χ|x₅(x₅−0.05Qₘₐₓ)≦0}
Guard(4₁,1)={x ∈ χ|(x₆−0.95Qₘₐₓ)(x₆−Qₘₐₓ)≦0}
The system may consist of 6 modes with vector fields in each mode of dimension 10. The vector fields may be polynomial in their variables, to facilitate the use of the sum of squares (SOS) decomposition for the analysis, and be of highest order 2. What may be required therefore is to construct 6 functions Bₗ as required by proposition 3 and have 4 SOS conditions for each one of them. All of the conditions but condition 5 may be of order 2 if B is of order 2. Condition 5 may be a higher order than the rest. With 10 state variables, the size of the LMI that is produced by this setup may be on the boundary of what can be solved using a SDP solver.

Another problem that may appear in such computations is inherent stiffness in the systems, i.e., having fast and slow dynamics, or even states that take values in different orders of magnitude. To alleviate this problem, we re-scale all states so that they are the same order of magnitude. Given the initial, unsafe, invariant and guard sets, a quadratic set of barrier functions may be constructed that proves the safety of the system.

The same verification may be performed with bed 11 degraded and its adsorption rate r_{ads}(CO₂,1) set to 155 g/hr. The control law may provide safe functionality in this case too, which is verified by constructing a barrier certificate.

Verification may be effected using statistical learning theory. An approach to verification may be to establish a safe operating envelope (SOE) within which, the control actions are safe, for a given set of initial conditions. No safety guarantees can be made about control actions outside the bounds of the SOE. Safety verification may thus be posed as essentially a problem of binary classification, where a “good” classifier may make a decision about a set of input data X, (in this case—the initial conditions) and categorize it into class Y: “safe” or “not safe” (Y={+1, −1}). The “goodness” of the classifier may be determined by the number and severity of its misclassifications, where false positives are considered more serious errors (where the classifier may erroneously categorize a certain set of inputs as safe under all conditions) than false negatives (which merely mean the classifier is being very conservative and maybe affecting performance). A good classifier may have zero false positives and minimum false negative errors.

The SOE for a system is determined from a framework based on statistical learning theory. (See “Statistical verification of two non-linear real-time UAV controllers,” by Binns, P., Elgersma, M., Ganguli, S., Ha, V., and Samad, T, in Real-Time and Embedded Technology and Applications Symposium, 2004, Proceedings, RTAS 2004, 10th IEEE.

The SOE may be “learned” from a set of simulation training samples. Thus, the system may be safe with only a finite statistical guarantee. The verification framework computes these statistical guarantees from Vapnik Chervonenkis style generalization bounds. Better statistical guarantees on classification can be obtained by tighter bounds, which may consequently result in smaller number of samples for training.

The basic learning problem may be indicated as the following. Given a set of inputs X and corresponding output set Y, one may determine that function which maps X to Y, with minimum error. Mathematically, this may be represented in the following. Let H be the space set of hypothesis functions that maps X to Y (in other words, the set of possible classifiers). One may define a training sample set Sₙ of size n, defined over input space X and output space Y, drawn according to a fixed unknown probability function (F(X,Y)) on Z=X×Y, such that
Sₙ={(xᵢ,yᵢ)}ᵢ₌₁ⁿ ∈ Zⁿ
For a hypothesis h, such that
h ∈ H
one may define a loss of hypothesis l(h) as

$$L \text{:} Y \times Y ->$$

$$l ( h ) = \int l ( h ( x ) , y ) ⅆ F ( x , y )$$

$${l}^{( ρ )} ( h ( x ) , y ) = \{ \begin{matrix}0 , h ( x ) = y \\ ρ , h ( x ) = - 1 , y = 1 , 0 \leq ρ \leq 1 \\ 1 , h ( x ) = 1 , y = - 1\end{matrix}$$

In the verification framework, one may define this loss to be the weighted classification error as follows. That is, the loss is zero, if the hypothesis result matches the true value of y for a given set x, it is 1 if the hypothesis gives a false positive and is a value ρ, which is the value of the weight given to a false negative. If ρ=1, this reduces to an unweighted classification error. When ρ=0, the loss function l reduces to the probability of making a false positive error.

Based on the actual and empirical classification error, and on learning parameters ε and δ, (where 1−δ is the confidence that the probability of the error may be less than or equal to the specified tolerance ε), an error metric to give a fundamental upper limit on the probability of the maximum classification error being less than the specified tolerance ε, may be defined in the following.

$$P [ {sup}_{h ∈ H} \vert l ( h ) - {l}_{emp} ( h ) \vert \leq ɛ ] \geq 1 - δ$$

This result may be used to derive the following relationship between the learning parameters, classification space complexity (measured by its Vapnik-Chervonenkis dimension d) and the number of training samples, m, used to learn the desired hypothesis:

$$\frac{2}{m} ( d {log}_{2} ( \frac{2 em}{d} ) + {log}_{2} ( \frac{2}{δ} ) ) \leq ɛ$$

Thus, for a given ε, δ and d, one may determine the minimum number of training samples, m, that satisfies the above condition, required to train a hypothesis, such that the required statistical guarantees of safety (given by ε and δ) are satisfied. This could be a significant result, as it may provide a limit on the size of the training set for a given classification problem, while still guaranteeing performance.

Based on the structure of the input space, different classifiers may be used for hypothesis generation. Some of the classifiers used for this problem may include the following. Hyperplanes may be separated. A hyper-plane in an n-dimensional space is characterized by the following linear equation,
α₁x₁+α₂x₂+α₃x₃+ . . . +αₙxₙ+αₙ₊₁=0
and divides the space into two sides: points that lie on one side of the plane are classified as acceptable, while points that lie on the other side are classified as unacceptable. A 0-1 classifier function may thus be formulated as
(1+sign(α₁x₁+α₂x₂+α₃x₃+ . . . +αₙxₙ+αₙ₊₁))/2
The problem of classification is finding that hyper-plane with no false positives and as few false negatives as possible.

Hyperrectangles may be bounded. A hyper-rectangle in an n-dimensional space may be characterized by the following bounds:
α_{ilb}<=xᵢ<=α_{iub} for i=1 . . . n
The hyper-rectangle may divide the space into two regions. The region enclosed by the hyper-rectangle may be safe or acceptable. The region falling outside the hyper-rectangle may be classified as unsafe.

In the statistical verification tool developed in by Binns, P., Elgersma, M., Ganguli, S., Ha, V., and Samad, T, in Real-Time and Embedded Technology and Applications Symposium, 2004, Proceedings, RTAS 2004, 10th IEEE, a heuristic approach may be used to determine the best hypothesis for the above two classifiers, that have zero false positives and minimum false negatives.

Support vector machines may be learning machines that can perform binary classification (pattern recognition) and real valued function approximation (regression estimation) tasks. Support vector machines may non-linearly map their n-dimensional input space into a high dimensional feature space. In this high dimensional feature space, a linear classifier may be constructed. The main concept of an SVM may be to find the optimal hyper-plane that satisfies the following conditions, which are: 1) Leaves the largest possible fraction of points of the same class on the same side; 2) Maximizes the distance of either class from the hyper-plane; and 3) Minimizes the risk of misclassifying training samples and unseen test samples.

In the case where the data may be represented by a linear function, construction of a separating hyper-plane is relatively straight forward. In the case where a linear boundary is inappropriate, the SVM may map the input vector, x, into a high dimensional kernel space, z. By choosing a non-linear mapping a priori, the SVM may construct an optimal separating hyper-plane in this higher dimensional space. Some common kernels used may be polynomials, radial basis functions and sigmoid functions. A decision surface may be computed in the kernel space that acts as a separating hyper-plane for the two sets of data. Support vector machines may be discussed in. “A Tutorial on Support Vector Machines for Pattern Recognition,” by C. J. C. Burges, in Knowledge Discovery and Data Mining, 2(2).

Safety verification of the NMPC controlled VCCR may be done using SLT. Safety specifications of the system may require that the O₂ and CO₂ concentrations in the cabin stay within the specified upper and lower bounds. The aim of the present verifier is to ensure that the controller maintains the safety condition, for different initial and operating conditions in the system. The safety criteria may be defined as follows: 1) For off nominal initial or operating conditions, the NMPC maintains cabin feasibility for at least 12 hours; and 2) For failure conditions, i.e., single side operations, the NMPC maintains cabin feasibility for at least 4 hours. The statistical verification framework may provide offline verification.

The following may be useful for an experimental set up. The following 8 input parameters in Table 8 may affect the cabin CO₂ and O₂ concentrations: 1) Initial CO₂ and O₂ concentrations in the cabin; 2) Initial CO₂ concentration in the solid phase of each adsorber bed; and 3) Adsorption (and corresponding desorption) rates in the beds.

TABLE 8
NUMBER OF TRAINING SAMPLES REQUIRED VS.
NUMBER OF INPUT PARAMETERS

| | Error | | | Training |
|---|---|---|---|---|
| Inputs | Tolerance | Confidence | Hypothesis | Samples |
| 8 | 0.05 | 0.95 | Hyperplane | 4296 |
| 8 | 0.05 | 0.95 | Hyperrectangle | 5094 |
| 8 | 0.05 | 0.95 | SVM | 4296 |
| 5 | 0.05 | 0.95 | Hyperplane | 2945 |
| 5 | 0.05 | 0.95 | Hyperrectangle | 4747 |
| 5 | 0.05 | 0.95 | SVM | 2945 |
| 2 | 0.05 | 0.95 | Hyperplane | 1593 |
| 2 | 0.05 | 0.95 | Hyperrectangle | 2044 |
| 2 | 0.05 | 0.95 | SVM | 1593 |

The size of the input space may be one of the factors that determines the VC dimension of the hypothesis space, which in turn determines the numbers of sample required to train a classifier, for a given confidence and error tolerance. Table 8 may show how the number of samples changes with the number of input parameters, for a given error tolerance and confidence, for different hypothesis spaces.

Limitations on the simulation time required per sample may govern the choice of the number of input parameters for experiments. One may want to use the minimum number of training samples for training, while at the same time, ensuring that the hypothesis space derived takes into account the interactive effects of all the input parameters on the output. This may be achieved by using the following blocking scheme in our design of experiments: 1) Number of varying input parameters: 2; and 2) Number of fixed input parameters: 6.

For each experimental block, 2 parameters may be allowed to vary between their lower and upper limits, while the rest of the parameters, may be fixed at nominal, high or low operating conditions. This may allow one to analyze the individual effects of the varying inputs, at different level settings or initial conditions in the system. The blocking structure used is shown in Table 9.

TABLE 9
DOE BLOCKING CRITERIA FOR SIMULATIONS FOR
OFF NOMINAL CONDITIONS

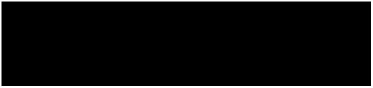

| | | | |
|---|---|---|---|
| I | Initial | Adsorb/ | NONE |
| | CO₂, O₂ in | Desorb Rates | |
| | Cabin | Initial CO₂ | |
| | | Holdup in | |
| | | Beds | |
| IIa | Adsorb | Initial CO₂ | HIGH |
| | Rates (and | Holdup in | Initial |
| | corresponding | Beds | CO₂, O₂ in |
| | desorb | | Cabin |
| | rates) | | |
| IIb | | Initial CO₂ | NONE |
| | | Holdup in | |
| | | Beds | |
| | | Initial CO₂, O₂ | |
| | | in Cabin | |
| IIIa | Adsorb | Initial CO2, O2 | HIGH |
| | Rates (and | in Cabin | Initial |
| | corresponding | | CO2 |
| | desorb | | Holdup |
| | rates) | | in Beds |
| IIIb | | Initial CO2, O2 | NONE |
| | | in Cabin | |
| | | Initial CO2 | |
| | | Holdup in | |
| | | Beds | |
| IIIc | | Initial CO2, O2 | LOW |
| | | in Cabin | Initial |
| | | | CO2 |
| | | | Holdup |
| | | | in Beds |

A second set of experiments may be conducted for single side operations, where the parameters varied are the initial concentrations of CO₂ and O₂ in the cabin, with the rest of the input parameters staying at the nominal values (except for the adsorption and desorption rates for the non-functioning bed).

One may pursue verification analysis and results. Of the experimental scenarios listed in Table 9, scenarios IIb and IIIb appear the same. In a preliminary analysis, tests on the nominal and medium level scenarios (IIb, IIc and IIIc), may be conducted to show that these are not limiting operating conditions and the controller is able to regulate the system to a regular cyclic pattern within the stipulated safety time limit. The scenarios of interest verified using SLT may be those which represent fault or off-nominal conditions, i.e., varying adsorption rates at high initial concentration in the cabin and in the beds. Also, verification for single side operations may be noted.

For the case of high initial CO₂ and O₂ cabin concentration, with varying adsorption and desorption rates, the initial concentrations in the cabin may be set at the upper specification limit:

CO₂: 12.07 g/m3

O₂: 279.35 g/m3 (the inert concentration may be assumed constant at 911.87 g/m3. The pressure within the cabin may also be assumed constant at 1 atmosphere.)

The adsorption rates (and corresponding desorption rates) in the beds may be varied between half nominal rate to nominal rate, i.e.,
84.141<=rᵢ^{des}<=168.282, i=1,2
Assuming a linear correlation between the adsorption and desorption rates, the corresponding desorption rates for the beds may be varied between
90.7<=rᵢ^{des}<=181.4, i=1,2

This scenario may be of interest as it appears to note the performance of the controller under two simultaneous extreme operating conditions: 1) when the cabin concentrations are very high to start with; and 2) both beds are not able to adsorb or desorb at full rate.

There may be a separating hyper-plane. In a verification run, the verifier tool may generate 100,000 random 2 dimension hyper-planes and use heuristics to determine that hyper-plane which produces zero false positives and minimizes the number of false negatives. The hypothesis generated from this run may be
(1 r₁^{ads})+(0 r₂^{ads})+(−168.282)=0
with a confidence of 95% and 0.054 error tolerance. This hypothesis may indicate that, for the specified initial conditions, as long as the adsorption rate in bed 1 stays within the upper bound, the controller maintain system safety for at least 12 hours, with the given statistical guarantees.

However, the hypothesis may also have generated about 107 false negatives (i.e., 7.25% of the training samples), which is quite large. This is because there may be the use of hyper-planes which constitute a simple hypothesis space that does not approximate the decision surface very well. The advantage to this may be that the VC dimension is low (VCD=3), and thus only a small number of samples may be required to ensure the statistical guarantee of low false positive probability.

The hypothesis was on 50 test samples and obtained 0 false positives and 3 false negatives. In order to get a better estimate of the safety boundary, a hyper rectangle classifier, described below.

There may be a bounding hyper-rectangle. In this case, 10000 random hyper rectangles were trained in 2 dimensions, to determine the hyper-rectangle that would minimize the number of false negatives. The VC Dimension of this hyper-rectangle may be 4, so for the same number of training samples and for a required 95% confidence, the error tolerance margin widened to 0.06. The number of random hyper-rectangles chosen, did not give significantly better results than the hyper-plane case, so the number was increased to 100,000 random hyper-rectangles to get the following result.

The hypothesis summary my include eerror tolerance −6.0%, confidence −95%, number of false positives −0, number of false negatives −47, wherein the hypothesis is:
154.84<=r₁^{ads}<=168.18,
150.05<=r₂^{ads}<=166.71.

Thus, the verifier appears to show that the controller may be able to maintain system safety for at least 12 hours, when the cabin is initially at a high level of concentration if the adsorption rates in the beds are at least 150 g//hr, in bed 2 (which starts off the cycle as the desorbing bed) and 154 g//hr, in bed 1.

This result may be in tune with an analysis of the system, where one does not expect the controller to sustain the system for 12 hours if rates fall below 90% of the nominal rates, as the system may hit its physical limits, within that time. In fact, for the system to remain stable for an infinite number of cycles, the rate of adsorption should match the rate of generation of CO₂ in the cabin, which is 152 g/hr.

For the sake of comparison, a statistical analysis of this system may be performed with a support vector machine (SVM). The SVM decision function nay be

$$f ( x ) = sign ( {\sum }_{i}^{l} {α}_{i} {y}_{i} K ( {x}_{i} x ) + b )$$

where i=1 . . . l, indicate those training samples used to compute the support vectors, b is the threshold or bias value, αᵢ are the non-zero Lagrange Coefficients, yᵢ are the corresponding labels in the training set and K(xᵢ, x) is the kernel used. Polynomial kernels of degree p may be represented by the function K(xᵢ, x)=(x•ᵢx+l)^{p}

One may chose a first degree and second degree polynomial kernel for analyses. The SVM kernel may involve a degree 1 polynomial. With a VC dimension of 3, the hypothesis may have been trained for 95% confidence and 5.35% error margin. The number of false positives on the training set was 1, number of false negatives was 1. On the test samples, the hypothesis performance was 0 false positives and 0 false negatives. The SVM kernel may involve a degree 2 polynomial. For this case, the VC dimension may have been 4 and thus the confidence was computed to be 95% for 6.67 % error tolerance. This hypothesis showed 0 false positives and 0 false negatives on the training as well as test samples, and thus appears as a better classifier.

For this case of high initial CO₂ holdup in adsorber beds, with varying adsorption and desorption rates, the initial concentrations in the cabin may be kept at nominal values, but the concentration of CO₂ in the bed that is first in the desorb cycle, was set at a high initial value—set at the upper specification limit.

CO₂: 400 g/m³

The adsorption rates (and corresponding desorption rates) in the beds may be varied between half nominal rate to nominal rate.

This scenario seems also of interest as it may note the performance of the controller under two simultaneous extreme operating conditions: 1) when the adsorption bed is are very high to start with; and 2) both beds are not able to adsorb or desorb at full rate.

A similar safety verification analysis, as the previous case, may be done using the three classifiers. The hyperplane classifier may show a hypothesis summary with error tolerance of 5.13%, a confidence of 95%, false positives on training samples of 0, false negatives on training samples of 208, with a hypothesis of (1 r₁^{ads})+(0 r₂^{ads})+(−168.282)=0.

Again, the above hypothesis appears to show that with 95% confidence and a 5.13% error margin, the controller may maintain safety in the system if the adsorption rate in bed 11 is within the upper bounds.

The hypothesis summary from our analysis with the hyperrectangle may have an error tolerance of 6.4%, a confidence of 95%, false positives on training samples of 0, false negatives on training samples 58, with a hypothesis involving:
147.82<=r₁^{ads}<=166.9
145.3208<=r₂^{ads}<=167.9
The SVM analysis for the problem does not appear to show a marked improvement in the statistical guarantees or in the performance on test samples.

In the case of single side operations, the performance of the NMPC may be noted, when one adsorber bed is not functioning, the second bed is adsorbing and desorbing at the nominal rate and the initial concentrations of CO₂ and O₂ in the cabin are varied between the upper and lower bounds. A study of the VCCR-NMPC system may show that it could sustain a single side operation for 5 hours, when operating at nominal initial conditions, before the system reaches its physical limits. Based on such observation, the safety criterion for the NMPC -VCCR system may be set to sustain feasibility under varying initial conditions to be at least 4 hours.

The hypothesis obtained by the hyperplane analysis may have a summary with an error tolerance of 5%, a confidence of 95%, false positives on training samples of 0, false negatives on training samples of 1273, with a hypothesis of
(−0.68ρ_{c}^{init}(CO₂))+(0.024 ρ_{c}^{init}(O₂)+(−1.3)=0

The hypothesis from hyperrectangle analysis may have a summary with an error tolerance of 5.85%, a confidence of 95%, false positives on training samples of 0, false negatives on training samples of 90, with a hypothesis of
7.83<=ρ_{c}^{init}(CO₂)<=9.6
272.36<=ρ_{c}^{init}(O₂)<=304.6
The hypothesis may show that if the concentration of CO₂ rises to about 80% of the maximum value, the controller will not be able to maintain feasibility within the system for the stipulated time limit of 4 hours.

SVM analysis of the system does not necessarily show improved results and appeared to show one false positive on the test samples.

In summary, several scenarios for safety verification of the VCCR system controlled by the NMPC were noted. For each scenario, the verifier hypothesized the following safety bounds (based on the findings from the hyperrectangle analysis), shown in Table 10.

TABLE 10
SUMMARY TABLE FOR STATISTICAL VERIFICATION RESULTS

| | Input | Initial | Hypothesis | Statistical |
|---|---|---|---|---|
| Set | Range | State | Summary | Guarantee |
| IIa | Adsorb | HIGH | 154.8 <= | 95% |
| | Rates | Initial | r₁^{ads} <= | Confidence |
| | (and | CO₂, O₂ | 168.2 | 0.06 |
| | corresponding | in Cabin | 150.1 <= | Error |
| | desorb | | r₂^{ads} <= | Bound |
| | rates) | | 166.7 | |
| | 84.14 <= | | | |
| | rᵢ^{ads} <= 168.28 | | | |
| IIIa | Adsorb | HIGH | 147.8 <= | 95% |
| | Rates in | Initial | r₁^{ads} <= | Confidence |
| | Beds | CO₂ | 166.9 | 0.06 |
| | (and | Holdup | 145.32 <= | Error |
| | corresponding | in Beds | r₂^{ads} <= | Bound |
| | desorb | | 167.9 | |
| | rates) | | | |
| | 84.14 <= | | | |
| | rᵢ^{ads} <= 168.28, | | | |
| IV | Initial | Single | 7.83 <= | 95% |
| | CO₂, O₂ | Side | ρ_{c}^{init}(CO₂) <= | Confidence |
| | in Cabin | Operations | 9.6 | 0.059 |
| | | | 272.36 <= | Error |
| | | | ρ_{c}^{init}(O₂) <= | Bound |
| | | | 304.6 | |

In conclusion, the use of barrier certificates as a method to verify safe performance of the heuristic controller was demonstrated. Recent progress in the construction of barrier functions for proving safety of dynamical systems may help one find an appropriate framework for safety verification of the life support system controlled by the heuristic controller. Although the controller and its switching rules may be simple, there appears not to be a closed form expression for the equilibrium sets of the closed loop hybrid system, and hence Lyapunov stability analysis and computation of region of attraction appear impossible. Construction of a barrier certificate for the controlled system may prove that it will not escape into unsafe operating regions. Although one may be able to provide a barrier certificate for the controlled system, there may be limits of what could be achieved with current computing capabilities on a desktop (10 states with 6 discrete modes). There may also be numerical difficulties in scaling semi-definite programming to larger dimensional problems.

Next, a statistical approach may be used to verify the safety performance of the NMPC, under various failure operating conditions. This approach appears to be a good trade off between exhaustive enumeration of all possible scenarios on one hand and rigorous numerical or formal methods on the other. The safety bounds determined by the statistical verifier seem to be less tight than those found by theoretical methods (barrier certificates). The safety bounds may depend on the definition of the safety criteria used for training the verifier and also on the statistical guarantees obtained from the system. As one increases the time bounds for safety criteria and the stringency in the safety guarantees, the number of simulations required to train such verifiers may go up. One may define multiple criteria for evaluating performance and make a trade off between the number of simulations required for training, the complexity of the verifier used and the maximum error bounds tolerated. This flexibility may make this method widely applicable to a wide variety of domains of increasing complexity and size.

The following is a list of various symbols used in the present description.

Notation: Subscripts

| | |
|---|---|
| c | Component |
| i | Quarter-cycle time slot |
| j | Absorber bed |
| fe | Finite element within a quarter-cycle |
| cp | Collocation point within a finite element |

Notation: Variables
1. Adsorber Beds

| | |
|---|---|
| ρ(c, j) | Fluid phase concentration of component c in adsorber bed j |
| ρ(c, i, j, fe, cp) | Fluid phase concentration of component c in adsorber bed |
| | j at collocation point cp within finite element fe in time slot i |
| ρ⁰(c, i, j, fe) | Fluid phase concentration of component c in adsorber bed |
| | j at the start of finite element fe in time slot i |
| ρ^{Gra}(c, i, j, fe, cp) | Gradient of the fluid phase concentration of component c |
| | in adsorber bed j at collocation point cp within finite element fe in |
| | time slot i |
| Q(c, j) | Solid phase mass of component c in adsorber bed j |
| Q(c, i, j, fe, cp) | Solid phase mass of component c in adsorber bed j at |
| | collocation point cp within finite element fe in time slot i |
| Q⁰(c, i, j, fe) | Solid phase mass of component c in adsorber bed j at the start of |
| | finite element fe in time slot i |
| Q^{Gra}(c, i, j, fe, cp) | Gradient of the solid phase mass accumulation of component c |
| | in adsorber bed j at collocation point cp |
| | within finite element fe in time slot i |

2. Cabin

| | |
|---|---|
| ρ_{C}(c) | Concentration of component c in crew cabin |
| ρ_{C}(c, i, fe, cp) | Concentration of component c in crew cabin at collocation |
| | point cp within finite element fe in time slot i |
| ρ_{C}⁰(c, i, fe) | Concentration of component c in crew cabin at the start |
| | of finite element fe in time slot i |
| ρ_{C}^{Gra}(c, i, fe, cp) | Gradient of the concentration of component c in crew |
| | cabin at collocation point cp within finite element fe |
| | in time slot i |
| y_{C}(c, i, fe, cp) | Mass fraction of component c in crew cabin at collocation |
| | point cp within finite element fe in time slot i |

3. Accumulator

| | |
|---|---|
| Q_{A}(c) | Mass of component c in the accumulator |
| Q_{A}(c, i, fe, cp) | Mass of component c in the accumulator at collocation |
| | point cp within finite element fe in time slot i |
| Q_{A}⁰(c, i, fe) | Mass of component c in the accumulator at the start of |
| | finite element fe in time slot i |
| Q_{A}^{Gra}(c, i, fe, cp) | Gradient of mass of component c in the accumulator at |
| | collocation point cp within finite element fe in time |
| | slot i |

4. Flow Streams

| | |
|---|---|
| ν₁, ν₁(i) | Total mass flow rate from the cabin to adsorbing bed, in |
| | time slot i |
| ν₂, ν₂(i) | Total mass flow rate from air-saving or desorbing bed, in |
| | time slot i |
| m(c), m(i, c) | Mass flow rate of component c into the crew cabin, in |
| | time slot i |

5. Time

| | |
|---|---|
| T(i) | Time duration of quarter-cycle time slot i |
| t_{i,fe} | Time point corresponding to the end of finite element fe |
| | in time slot i |
| τ_{i,fe,cp} | Time point at collocation point cp within finite element fe in time |
| | slot i |
| t_{i,0} | Time point corresponding to the start of time slot i |
| t_{i,f} | Time point corresponding to the end of time slot i |

Notation: Parameters

| | |
|---|---|
| r_{C}(c) | Rate of generation of component c in the crew cabin |
| r_{ads}(j, c) | Rate of adsorption of component c in adsorber bed j |
| r_{des}(j, c) | Rate of desorption of component c in adsorber bed j |
| Vⱼ | Fluid phase volume of adsorber bed j |
| V_{C} | Crew cabin volume |
| Ω(cp, cp′) | Multipliers for Cubic Roots for collocation |

In the present specification, some of the matter may be of a hypothetical or prophetic nature although stated in another manner or tense.

Although the invention has been described with respect to at least one illustrative example, many variations and modifications will become apparent to those skilled in the art upon reading the present specification. It is therefore the intention that the appended claims be interpreted as broadly as possible in view of the prior art to include all such variations and modifications.

1. A system for controlling a life support mechanism comprising:
a system description module;
a model development module connected to the system description module;
a time modeling module connected to the model development module;
a non-linear program formulation module connected to the time modeling module; and
a non-linear model predictive control module connected to non-linear program formulation module.

2. The system of claim 1, wherein the time modeling module comprises:
an inter-mode switching time sub-module; and
an intra-mode dynamics time sub-module.

3. The system of claim 2, wherein the model development module comprises:
a hybrid modes sub-module; and
a dynamic equations sub-module.

4. The system of claim 3, wherein the model development module further comprises a system model sub-module connected to the hybrid modes submodule and the dynamic equations sub-module.

5. The system of claim 4, wherein the model development module further comprises a system assumptions sub-module.

6. The system of claim 2 wherein:
the inter-mode switching time modeling sub-module has a mode time interval that the system spends in each of the various hybrid modes;
the intra-mode dynamics modeling sub-module has the mode time interval comprising a plurality of finite elements; and
each finite element of the plurality of finite elements, comprises a plurality of collocation points.

7. The system of claim 2, wherein the non-linear model predictive control module comprises:
a testing and/or control tuning sub-module connected to the non-linear model predictive control module; and
a control objectives sub-module connected to the non-linear model predictive control sub-module.

8. The system of claim 7, wherein:
the testing and/or control tuning sub-module outputs objective function weights tuning; and
the control objectives sub-module outputs objective function development information.

9. The system of claim 8, wherein the objective function weights tuning and objective function development information are output as enhancements and/or corrections to the non-linear model predictive control module.

10. The system of claim 8, wherein the inter-mode switching time sub-module and the intra-mode dynamics time sub-module compose a unified time formulation.

11. A system of life support mechanism control system comprising:
an air recovery mechanism;
a simulator connected to the air recovery mechanism; and
a non-linear model predictive controller connected to the simulator.

12. The system of claim 11, wherein the simulator is for providing a model of the variable configuration removal mechanism.

13. The system of claim 11, wherein the non-linear model predictive controller has a unified inter-mode switching control and intra-mode dynamic control.

14. A method for controlling a life support system comprising:
describing the system;
developing a model of the system;
modeling inter-mode switching time;
modeling intra-mode dynamics time;
formulating a non-linear model predictive controller comprising information of the system, inter-mode switching time and intra-mode dynamics time.

15. The method of claim 14, wherein the developing a model of a system comprises hybrid modes, system assumptions and/or dynamic equations.

16. The method of claim 15, further comprising:
testing and/or tuning the controller; and
providing objective function development.

17. The method of claim 14, wherein the inter-mode switching time and the intra-mode dynamics time are of a unified formulation.

18. The method of claim 15, wherein each of the hybrid modes is described by a set of equations.

19. The method of claim 18, wherein the set of equations is a set of differential or difference equations.

20. A means for controlling a life support system comprising:
means for developing a model of a system;
means for providing a unified formulation of inter-mode switching time and intra-mode dynamics time, connected to the means for developing a model of a system; and
means for non-linear model predictive controlling comprising information of the model of the system and of the unified formulation of inter-mode switching time and intra-mode dynamics time.

21. A system of VCCR control within an air recovery system, within a life support system comprising:
a VCCR mechanism;
a simulator connected to the VCCR mechanism; and
a non-linear model predictive controller connected to the simulator.

22. A method for controlling a VCCR system, within an air recovery system, within a life support system comprising:
describing the system;
developing a model of the system;
modeling inter-mode switching time;
modeling intra-mode dynamics time;
formulating a non-linear model predictive controller comprising information of the system, inter-mode switching time and intra-mode dynamics time.

23. Means for controlling a VCCR system, within an air recovery system, within a life support system comprising;
means for developing a model of a system;
means for providing a unified formulation of inter-mode switching time and intra-mode dynamics time, connected to the means for developing a model of a system; and
means for non-linear model predictive controlling comprising information of the model of the system and of the unified formulation of inter-mode switching time and intra-mode dynamics time.

24. A system for controlling a variable configuration carbon dioxide removal within an air recovery system, within a life support mechanism, comprising:
a system description module;
a model development module connected to the system description module;
a time modeling module connected to the model development module;
a non-linear program formulation module connected to the time modeling module; and
a non-linear model predictive control module connected to non-linear program formulation module.
